(19) United States
(12) Patent Application Publication
(10) Pub. No.: US 2014/0101312 A1
(43) Pub. Date: Apr. 10, 2014

(54) ACCESS ALLOCATION IN HETEROGENEOUS NETWORKS

(71) Applicant: Transpacific IP Management Group Ltd., Taiwan (CN)

(72) Inventors: Ching-Yao Huang, Taiwan (CN); Chie-Ming Chou, Taiwan (CN)

(21) Appl. No.: 13/870,757

(22) Filed: Apr. 25, 2013

Related U.S. Application Data
(60) Provisional application No. 61/711,664, filed on Oct. 9, 2012.

(51) Int. Cl. H04L 29/06

(52) U.S. Cl. CPC H04L 29/06469
USPC 709/225

(57) ABSTRACT

Radio resource management and access allocation is provided in heterogeneous networks. Sequential access allocation in heterogeneous networks is facilitated based on multiple scheduling priorities. In addition, clustering and grouping during access allocation is allowed for heterogeneous networks.

### CROSS-REFERENCE TO RELATED APPLICATIONS

This application claims priority to U.S. Provisional Patent Application Ser. No. 61/711,664, filed on Oct. 9, 2012, and entitled METHOD AND APPARATUS OF ACCESS ALLOCATION IN HETEROGENEOUS NETWORK, the entirety of which is hereby incorporated by reference.

### TECHNICAL FIELD

The subject disclosure is directed to mobile communications, e.g., to radio resource management and access allocation in heterogeneous networks.

### BACKGROUND

Heterogeneous Networks (HetNets) have been included in the scope of the Long Term Evolution Advanced (LTE-A) Third Generation Partnership Project (3GPP) standardization study items. Typically, a HetNet can be comprised of traditional large macrocells and smaller cells including microcells (e.g., less than five Watts (W)), picocells (e.g., less than one W), and femtocells (e.g., approximately 200 milliWatts (mW)), with capability to employ Wi-Fi® as a mechanism to offload traffic. HetNets can typically comprise two categories of Evolved NodeBs (eNBs), including the traditional macro eNBs and non-traditional access nodes. The non-traditional access nodes can include Pico eNBs or hot-zone cells, Femto eNBs or Home eNB, Remote Radio Head (RRH) and Relay nodes. In general, the benefits of Het-Net include: 1) significant gains in area capacity through aggressive spectrum reuse, 2) favorable cost structure of non-traditional nodes, and 3) improved indoor coverage and capacity.

In addition, before developing Fourth Generation of mobile phone mobile communications standards (4G) for wireless communication systems, different radio access technologies, such as Wireless Local Area Network (WLAN), Wireless Wide Area Network (WWAN), and different types of access nodes, for example, were operated individually. To take advantage of advanced antenna technologies and to utilize existing network infrastructure and entities, the integration of different radio access technologies and different types of eNB is part of 4G system evolution. However, like Software Defined Radio (SDR) technologies, an integration of all technologies may increase chip complexity and may not be realized and/or be compatible with original products.

Thus, a HetNet has been proposed in 4G mobile networks to enhance overall network performance by adding non-traditional access nodes while the non-traditional access nodes are operated with small transmission power and a different backhaul connection. A centralized management technique called Cloud-based Radio Resource Management (RRM) can be used to arrange a proper transmission, for which, the transmission can be selectively implemented by access nodes and resources for a user equipment (UE) using similar access arrangement techniques. This arrangement, called Sub-Access System (SAS) allocation, can be configured to be adaptive according to a network's and/or according to one or more of subscribers' situations.

For instance, a cloud server (CS) can be configured to collect available information from UE and access nodes, so as to allocate respective SAS resources for each UE. However, with an increasing number of access nodes and subscribers, for which, each subscriber can have varying and different criteria, it is conceivable that cost-prohibitive computing complexity of the CS can increase linearly with UE additions simply to compute appropriate allocations. For instance, a conventional CS can be configured to try all possible SAS allocations among every UE, such that the attendant computational complexity can degrade Cloud-based RRM performance. Thus, currently, SAS allocations for the dynamic combination of UEs and eNBs are not fast or efficient.

In conventional coordinated resource allocation solutions, such as where a UE can be served by multiple nodes, cooperating cells typically employ their own coordinated scheduling and/or perform resource allocation according to coordinated approaches. For example, in such conventional coordinated resource allocation solutions, coordinated cells may change respective transmission timely to reflect channel variance, and resources can be allocated on a special time interval, where a cooperating set will be maintained to facilitate such allocations. However, it can be understood that such a dedicated set of resources can be unnecessarily inflexible and/or wasteful of system resources in rapidly changing environments, such as where highly mobile UEs can be introduced and removed from consideration in the time frame of reference.

In other conventional systems that attempt to address inter-cell interference in HetNets, grouping on the control channel typically employs grouping of several physical resource blocks (PRBs) dedicated for associating UEs. It can be understood that randomization of a resource group or an interleaved structure can reduce inter-cell interference. Besides, with grouping on PRB, the number of scheduled resources can be reduced to the number of grouped resources, which can speed up scheduling. However, such grouping can result in increased scheduling dimension and associated computational complexity.

In yet other conventional systems involving delay-sensitive applications, conventional cross-layer optimization can be employed to account for heterogeneous and changing characteristics of delay-sensitive applications and time-varying network conditions. However, such techniques typically employ a complex algorithm to select appropriate programming on each layer to facilitate jointly determining a dynamic result. As a result, the complexity of such algorithms intended to take all components into account may be unnecessarily unresponsive to time-variance of network conditions or overly complex for some situations, such as where a rough, but fast-acquiring, response suffices.

The above-described deficiencies of conventional RRM practices are merely intended to provide an overview of some of the problems of conventional systems and methods, and are not intended to be exhaustive. Other problems with conventional systems and corresponding benefits of the various non-limiting embodiments described herein may become further apparent upon review of the various non-limiting embodiments of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In various non-limiting embodiments, the disclosed subject matter relates to RRM and access allocation in heterogeneous network environments, e.g., HetNets. In one non-limiting aspect, the disclosed subject matter facilitates sequential access allocation in heterogeneous networks based on multiple scheduling priorities, as described below regarding FIGS. 2-9, etc., for example. In further non-limiting aspects, the disclosed subject matter allows clustering and/or grouping during access allocation for heterogeneous networks, according to various non-limiting implementations described herein, to further reduce computational complexity, while providing efficient allocation techniques, as described herein.

For instance, to the foregoing and related ends, various embodiments are disclosed that can facilitate access allocation in HetNets according to various aspects of the disclosed subject matter, among other related functions. Accordingly, non-limiting embodiments of the disclosed subject matter can provide example methods that facilitate network access allocation. In further non-limiting implementations, example methods can facilitate sequentially allocating components of a network node, such as resource blocks, behavior, etc. to a communication device, such as a user device or equipment, based on two identified scheduling priorities. In addition, further example implementations are directed to systems, devices and/or other articles of manufacture that facilitate access allocation in HetNets, as further detailed herein.

These and other features of the disclosed subject matter are described in more detail below.

### BRIEF DESCRIPTION OF THE DRAWINGS

The devices, components, systems, and methods of the disclosed subject matter are further described with reference to the accompanying drawings in which:

FIG. 1 depicts a functional block diagram illustrating an example environment suitable for use with aspects of the disclosed subject matter;

FIG. 2 illustrates a block diagram depicting example concepts applicable to aspects of the disclosed subject matter;

FIG. 3 illustrates typical complexity of an example SAS allocation in a non-limiting system comprising a set of (N) UEs, (M) eNBs, and (K) RBs;

FIG. 4 depicts a performance cumulative distribution function (CDF) in an example wireless network;

FIG. 5 is a functional block diagram of a multi-slope identification and scheduling algorithm (e.g., a two-slope identification and scheduling algorithm, etc.) that facilitates Cloud-based RRM;

FIG. 6 depicts Reference Signal Received Power (RSRP) as a function of UE location with respect to two eNBs (e.g., eNB1 and eNB2);

FIG. 7 demonstrates an example multi-slope scheduling (e.g., two-slope scheduling), in which overall SAS scheduling can be treated as a selection of dimensions in a two dimensional (2-D) space, where horizontal dimension can be RB allocation and a vertical dimension can be an eNB allocation;

FIG. 8 is a functional block diagram of a two-slope identification and scheduling algorithm employing clustering and/or grouping that facilitates Cloud-based RRM;

FIG. 9 illustrates an example non-limiting flow diagram of methods for performing aspects of embodiments of the disclosed subject matter;

FIG. 10 illustrates a further non-limiting flow diagram of methods for performing aspects of embodiments of the disclosed subject matter;

FIG. 11 illustrates an overview of an example computing environment suitable for incorporation of embodiments of the disclosed subject matter;

FIG. 12 depicts a functional block diagram illustrating example non-limiting devices or systems suitable for use with aspects of the disclosed subject matter;

FIG. 13 depicts an example non-limiting device or system suitable for performing various aspects of the disclosed subject matter;

FIG. 14 illustrates an example non-limiting device or system suitable for performing various aspects of the disclosed subject matter;

FIG. 15 is a block diagram representing example non-limiting networked environments in which various embodiments described herein can be implemented;

FIG. 16 is a block diagram representing an example non-limiting computing system or operating environment in which one or more aspects of various embodiments described herein can be implemented;

FIG. 17 illustrates a schematic diagram of an example mobile device (e.g., a mobile handset, user device, or user equipment) that can facilitate various non-limiting aspects of the disclosed subject matter in accordance with the embodiments described herein;

FIG. 18 is a block diagram representing an example non-limiting computing system or operating environment in which aspects of the disclosed subject matter may be implemented; and

FIG. 19 is a block diagram representing another non-limiting computing system or operating environment in which further aspects of the disclosed subject matter may be implemented.

### DETAILED DESCRIPTION

### Overview

As described above, deficiencies of conventional RRM practices can result in overly complex algorithms, increased computational complexity, and/or unacceptable performance tradeoffs resulting from unnecessarily inflexible allocation systems and/or wasteful use of system resources in rapidly changing environments. Accordingly, in various embodiments, rapid convergence of SAS allocations for the dynamic combination of UEs and eNBs is provided. For example, SAS allocation without maintaining a dedicated cooperating set of eNBs can provide a more flexible approach with higher system resource utilization, due in part to the fact that no additional set of eNBs need be signaled (e.g., between an eNB and UE) when there are updates in the system. Moreover, a source eNB need not negotiate a target eNB regarding the set of eNBs for a prospective UE handover. In various non-limiting implementations of the disclosed subject matter, SAS allocation can also appear transparent to UEs, as described herein. In further non-limiting implementations, grouping on the UEs in a HetNet can result in UEs having identical resources on respective eNBs, where such grouping can facilitate utilizing resources without inter-cell interference while reducing scheduling dimension.

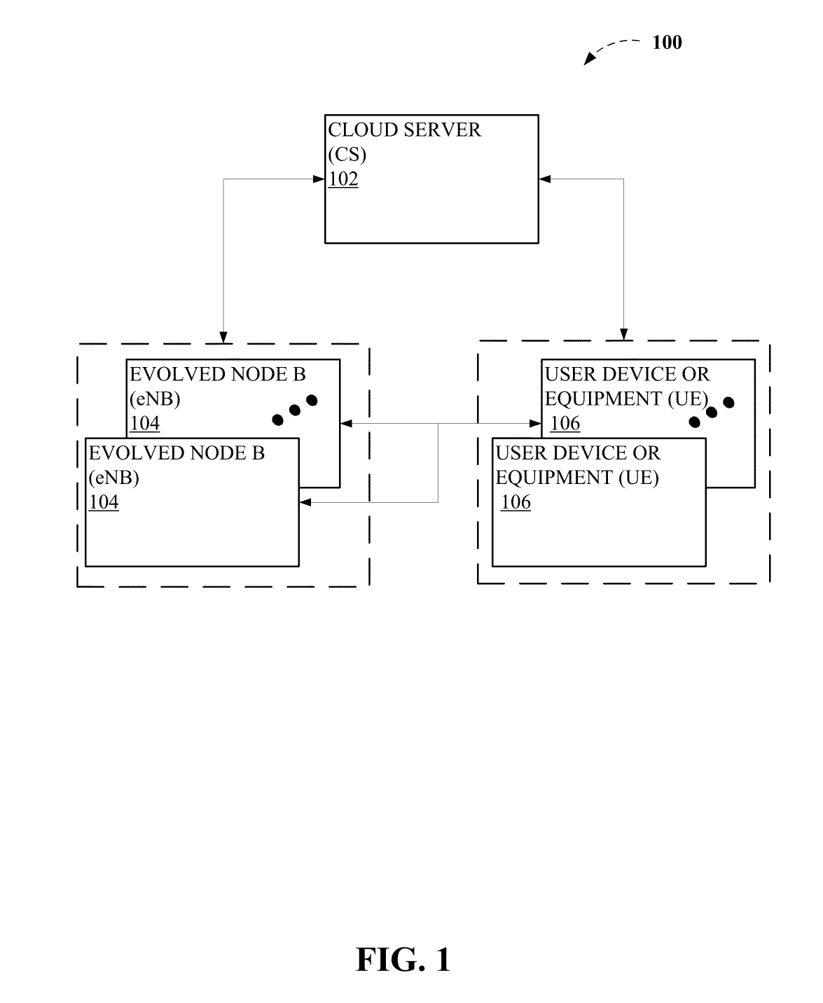

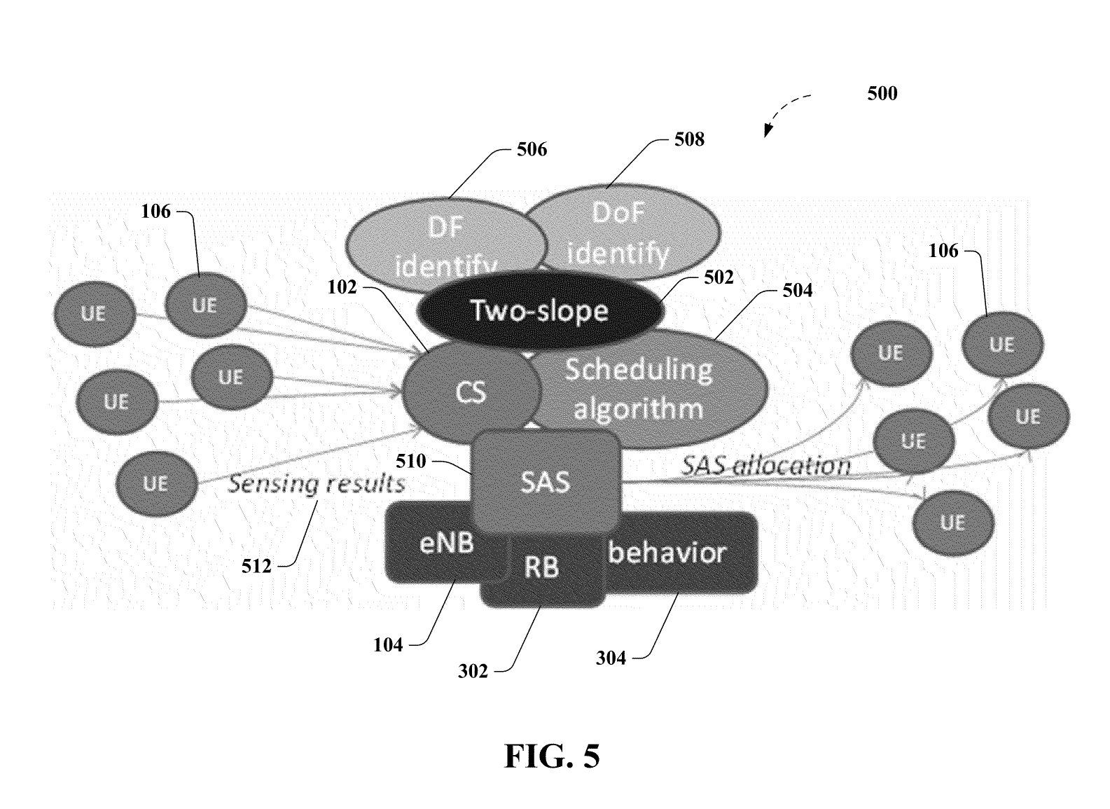

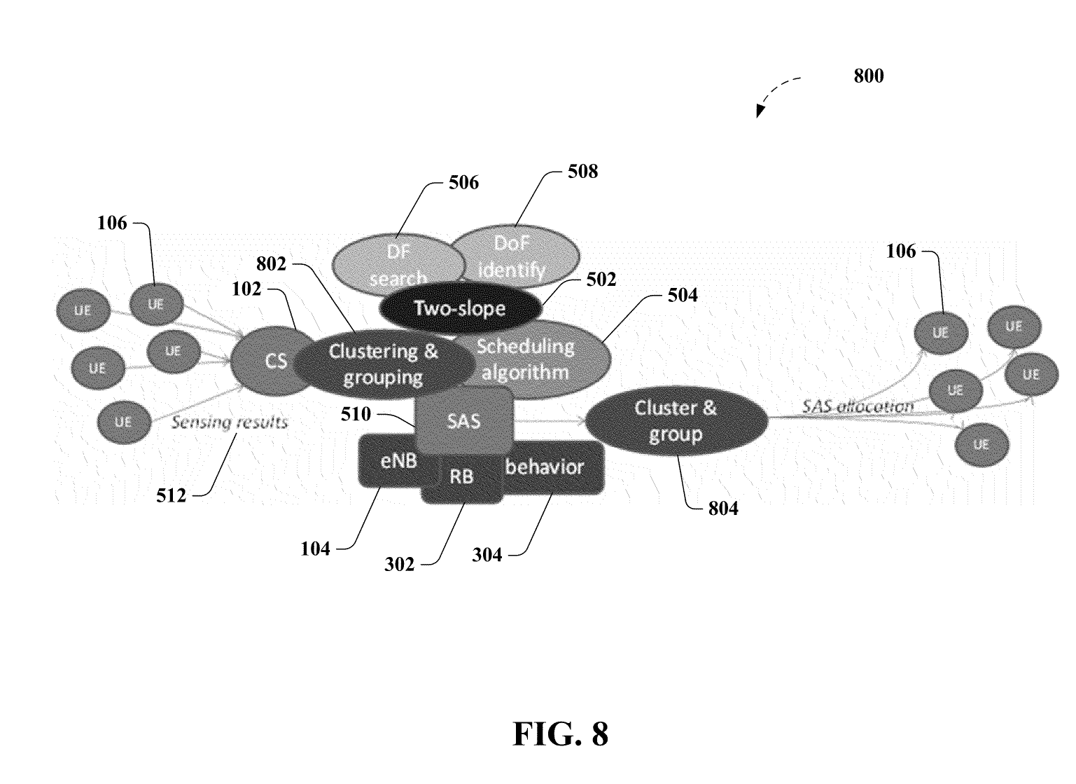

Thus, to the foregoing and related ends, systems, devices, and methods are disclosed that can facilitate access allocation in HetNets according to various aspects of the disclosed subject matter, among other related functions. FIG. 1 depicts a functional block diagram illustrating an example environment 100 suitable for use with aspects of the disclosed subject matter. According to various non-limiting aspects, example environment 100 can comprise one or more of a cloud server, or CS 102, one or more evolved Node Bs, or eNBs 104, and/or one or more user equipment or devices, or UEs 106. In various embodiments of the disclosed subject matter, methods and architectures of SAS allocation for Cloud-based RRM are provided. By identifying special factors from sensing results from one or more UEs 106, such as described herein regarding FIGS. 5-6, and 8, and/or clustering and/or grouping UEs 106 with similar characteristic, such as described herein regarding FIG. 8, various non-limiting implementations of a CS 102 can prioritize and simplify SAS allocations for one or more UEs 106. As a result, a proper allocation can be achieved with substantially reduced computing and hardware costs.

Accordingly, by using Cloud-based RRM implementations, a wireless operator can utilize properly configured eNBs 104 and licensed radio resources through an example CS 102, according to various aspects described herein, which CS 102 can evaluate concurrent environments and choose a suitable SAS to serve a UE 106. The SAS chosen by various non-limiting implementations of a CS 102 can comprise a set of candidate eNBs 104, a kind of access behavior with resource block selection, etc. It can be observed that there is an amount of dimensioning during allocation, the selection of which can influence system performance significantly. In various non-limiting implementations of the disclosed subject matter, a multi-slope scheduling algorithm (e.g., a two-slope scheduling algorithm, etc.) is described, which can provide fast SAS allocation, according to various non-limiting aspects. Moreover, in other non-limiting implementations, UEs 106 can be divided into different clusters and/or groups, which can facilitate combining proposed scheduling, and which can further reduce computing complexity. Thus, various embodiments can provide a near immediate decision and/or a close-optimization to reflect concurrent changes on a HetNet without a computationally complex exhausting search.

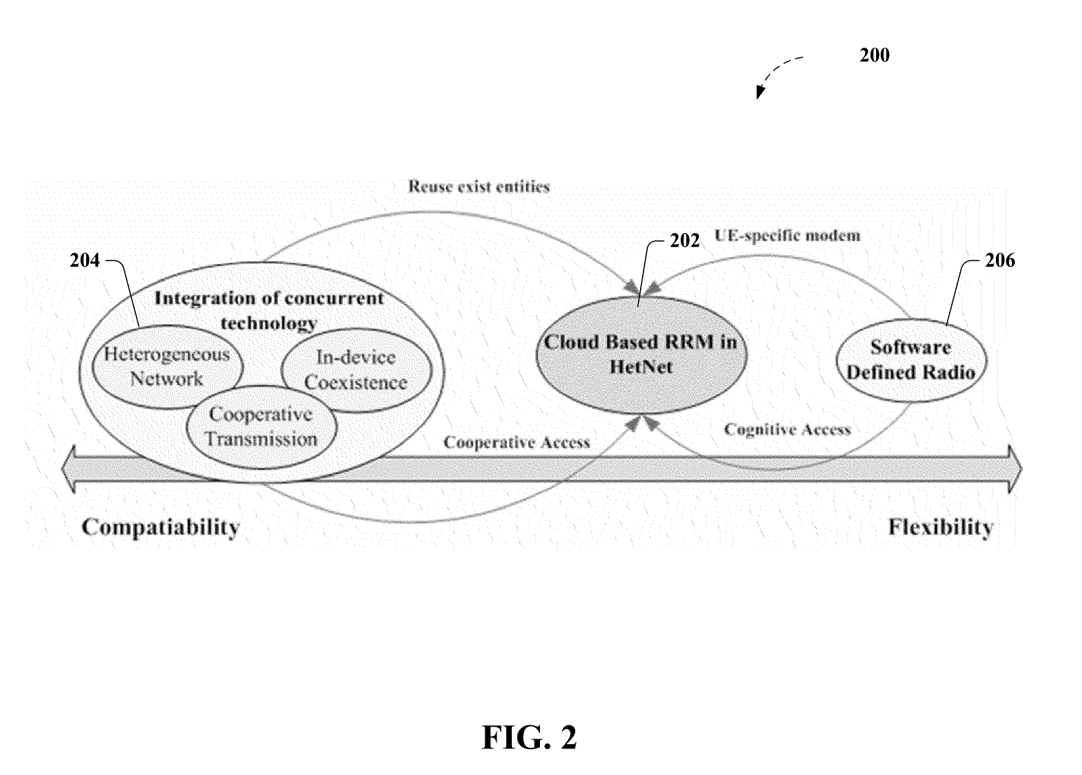

FIG. 2 illustrates a block diagram 200 depicting example concepts applicable to aspects of the disclosed subject matter. As described above, an alternative technology called Cloud-based RRM 202 in HetNet 204 as illustrated in FIG. 2 has been developed. Within the context of a network, cloud computing typically refers to providing hosted services over the Internet, which hosted services can be an agent to provide facilities to enable its users to run applications. For example, a user device or UE 106 can run cloud computing applications without adding complex hardware but while using communications to acquire the execution results. As a result, cloud computing can be employed as a SDR 206, while each user device, or UE 106, can maintain its original access elements by adding only one or more communication interface(s) with a host to acquire the flexibility and applications. As such, a host (e.g., an example CS 102, etc.) according to various non-limiting aspects can be configured to provide central controls for all connected devices and facilitate device adaptation to facilitate achieving ideal or near ideal transmissions. In various non-limiting implementations, an objective of ideal or near ideal transmissions (e.g., an objective of maximum spectrum efficiency, maximum energy efficiency, maximum data rate, minimum transmission delay, etc.) could be defined by CS 102 and/or UE 106. The host, which can be a CS 102 according to various aspects as described herein, can connect UEs 106 to a specific system, e.g., a SAS, by constituting appropriate access components from a HetNet 204.

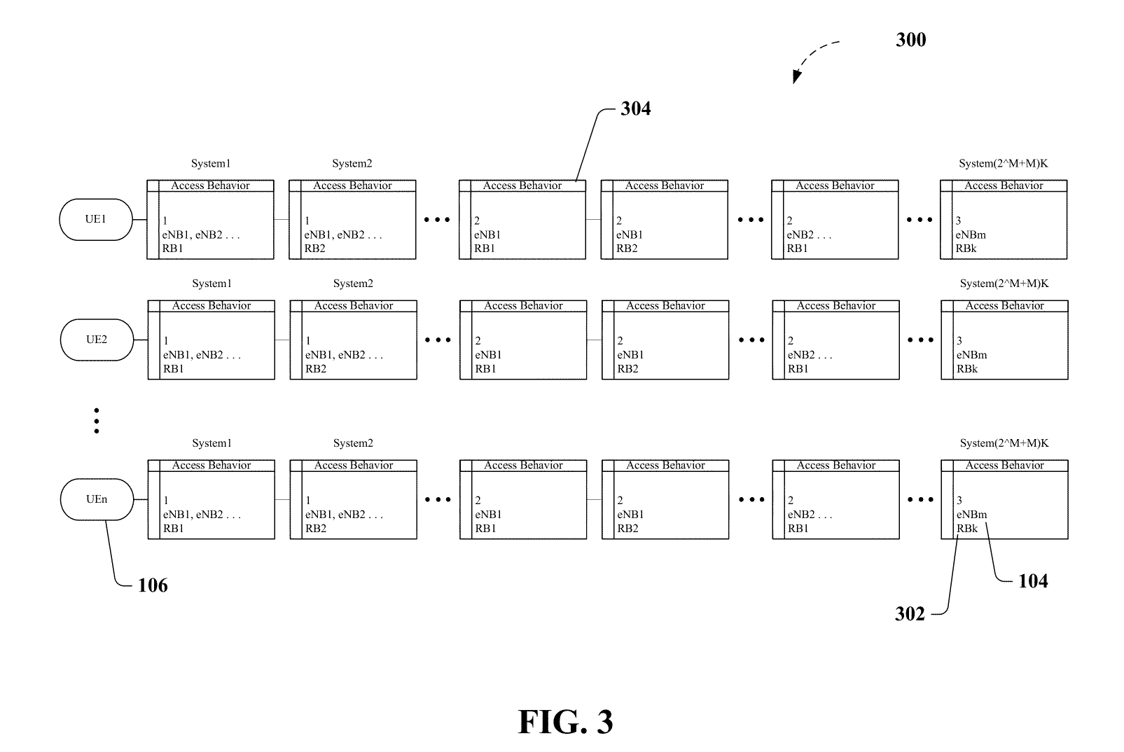

FIG. 3 illustrates typical complexity of an example SAS allocation in a non-limiting system 300 comprising a set of (N) UEs 106, (M) eNBs 104, and (K) RBs 302. In non-limiting implementations, a CS 102 configured according to various aspects of the disclosed subject matter can perform RRM 202 based on feedback information, which, in turn, can facilitate determining a SAS for a UE 106, where the determination of a SAS can further comprise behavior 304 selection and resource block (RB) 302 selection, as further described herein. According to a non-limiting aspect, behavior 304 selection can comprise deciding which eNBs 104 of a set of eNBs 104 are to be responsible for serving a UE 106 in a specific behavior 304. In other non-limiting aspects, depending on adopted access behavior 304, for example, responsible eNBs 104 can make transmission simultaneously and/or sequentially, and the transmitted packets can be identical or different.

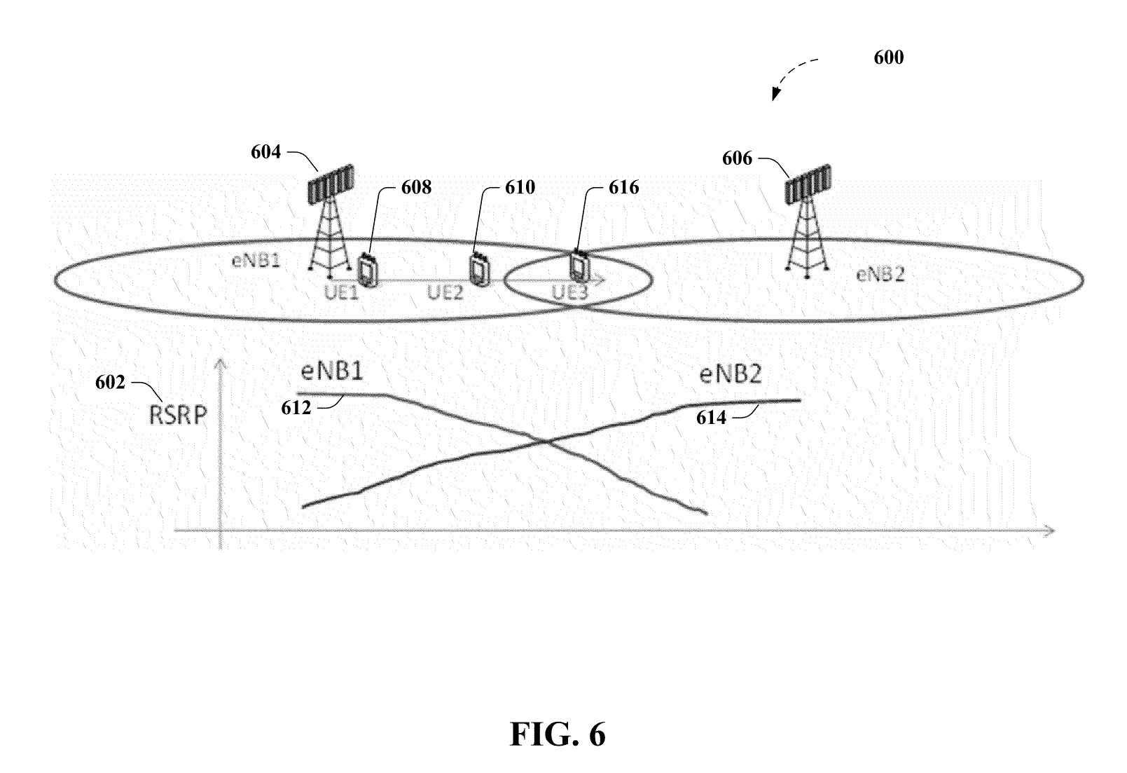

Accordingly, systems configured to facilitate RRM 202 as described herein can support such behaviors 304 among eNBs 104 including one or more of cooperative behavior, unique behavior, and/or cognitive behavior, and/or combinations thereof, and the like, such as described herein regarding FIGS. 2 and 6, for example. In still further non-limiting implementations of the disclosed subject matter, a CS 102 can change behavior decisions based in part on receiving feedback from UEs 106 and/or eNBs 104, such as illustrated in FIGS. 1-2, where such changes can include behavior transition or modifications for associated eNBs 104.

In a further non-limiting aspect, RB 302 selection can be used to determine which RBs 302 can be suitable for UE 106 transmission. As a non-limiting example, one or more criteria for RB 302 selection can depend in part on channel fading, interference condition, and/or other criteria, and/or combinations thereof. Because the amount of RB 302 is fixed and is a constrained resource, it is important to determine methods to maximize possible transmissions by the limited amount of RB 302 and to utilize the limited amount of RB 302 as efficiently as possible to achieve best performance for a UE 106.

As described herein, a CS 102 can arrange SAS for one or more UEs 106 and can determine and/or assign an appropriate composition of behaviors 304 selection and RB 302 selection for a best or an optimal overall HetNet performance. As compared with conventional RRM 202, it can be understood that additional considerations associated with Cloud-based RRM 202, such as behavior 304 selection and RB 302 selection, can result in significant increases in complexity without further techniques to reduce such complexity. For instance, FIG. 3 depicts the total possible compositions for a non-limiting system comprising a set of (N) UEs 106, (M) eNBs 104, and (K) RBs 302. Thus, FIG. 3 demonstrates that there would have to be M×K×2^{N} possible choices for a CS 102 to allocate SAS for each UE 106 in the non-limiting example system. It can be appreciated that the computational complexity can be significantly large and can require detrimentally lengthy computing times in finding a proper allocation in an exhaustive search, for example. To resolve such problems, as further described herein, various non-limiting implementations of the disclosed subject matter provide Cloud-based RRM 202 based in part on a fast convergence to a solution, according to various non-limiting aspects.

While a brief overview has been described above in order to provide a basic understanding of some aspects of the specification, various non-limiting devices, systems, and methods are now described as a further aid in understanding the advantages and benefits of various embodiments of the disclosed subject matter. To that end, it can be understood that such descriptions are provided merely for illustration and not limitation.

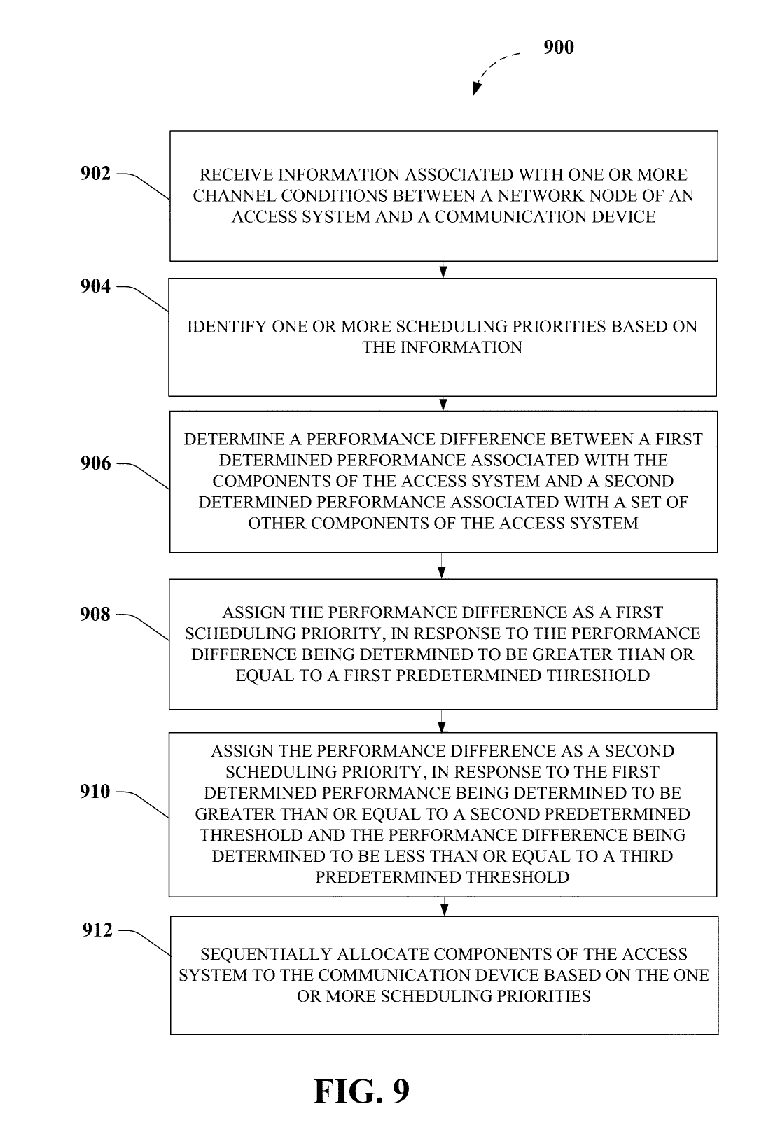

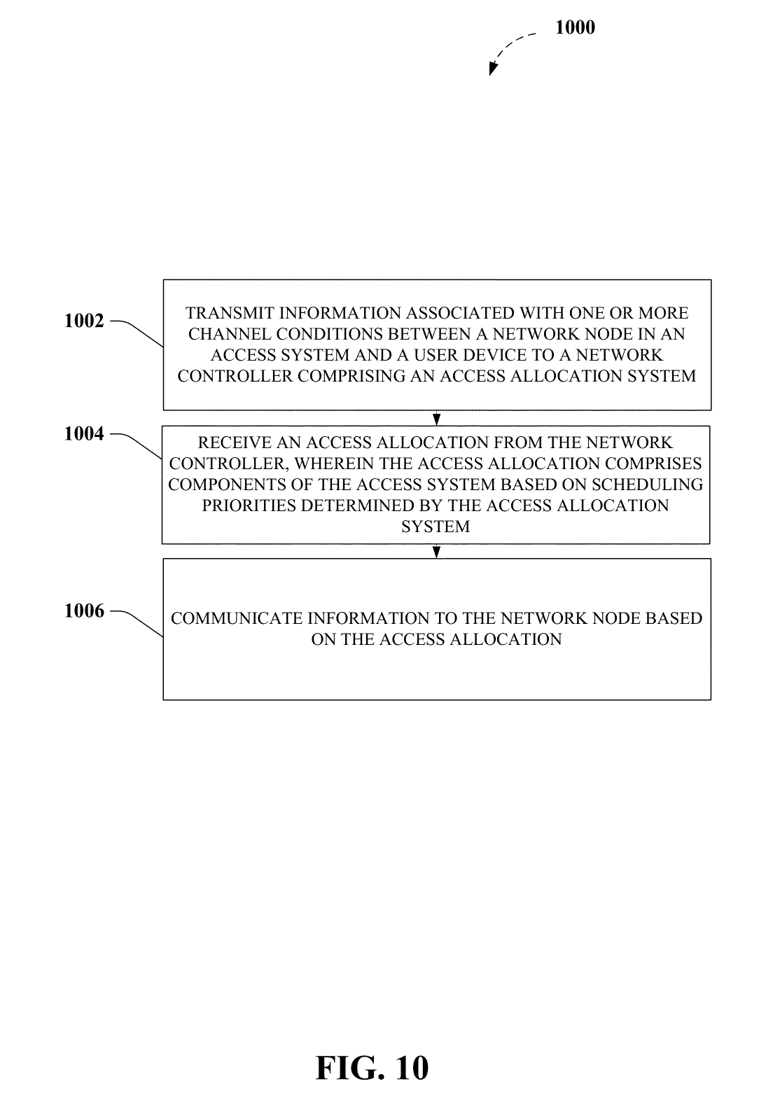

In view of the example embodiments described supra, methods that can be implemented in accordance with the disclosed subject matter will be better appreciated with reference to the flowcharts of FIGS. 9-10, for example. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methods described hereinafter. Additionally, it should be further understood that the methods and/or functionality disclosed hereinafter and throughout this specification are capable of being stored on an article of manufacture to facilitate transporting and transferring such methods to computers, for example, as further described herein. The terms computer readable medium, article of manufacture, and the like, as used herein, are intended to encompass a computer program accessible from any computer-readable device or media such as a tangible computer readable storage medium.

### EXAMPLES

In general, it can be straightforward to use exhaustive search techniques to check all possible SAS allocations to achieve optimal performance. For example, if every UE 106 can be allocated with the best SAS, then overall performance can be expected to also be optimized. As a non-limiting example, various performance metrics for optimization can be based on throughput, spectrum efficiency, energy-efficiency, signal to interference plus noise ratio (SINR), etc., while allocation results can be associated with corresponding performance metric values that can be evaluated (e.g., by a CS 102, etc.). However, as mentioned above, the complexity would be significantly high such that it would be cost prohibitive, for example. In addition, it can be further understood that such exhaustive search techniques can result in selected SAS for respective UEs 106 that may be conflicted. For example, the best SAS selection can be the same for more than one UE 106, but the best SAS selection can be allocated for only one UE 106 at any instance in time.

In other non-limiting implementations, a collision scheduling scheme can be provided to decide which UE 106 can be allocated the best SAS, and to compel the other collided UEs 106 to choose among other SAS allocations. However, it is expected that the design of such a collision scheduling scheme would have a detrimental impact on final performance and further increase the scheduling complexity, simply based on the consideration of several issues (e.g., scheduling fairness, etc.). Accordingly, as described herein, the disclosed subject matter, provides a multi-slope scheduling algorithm (e.g., a two-slope scheduling algorithm, etc.) to find overall SAS allocation for each UE 106.

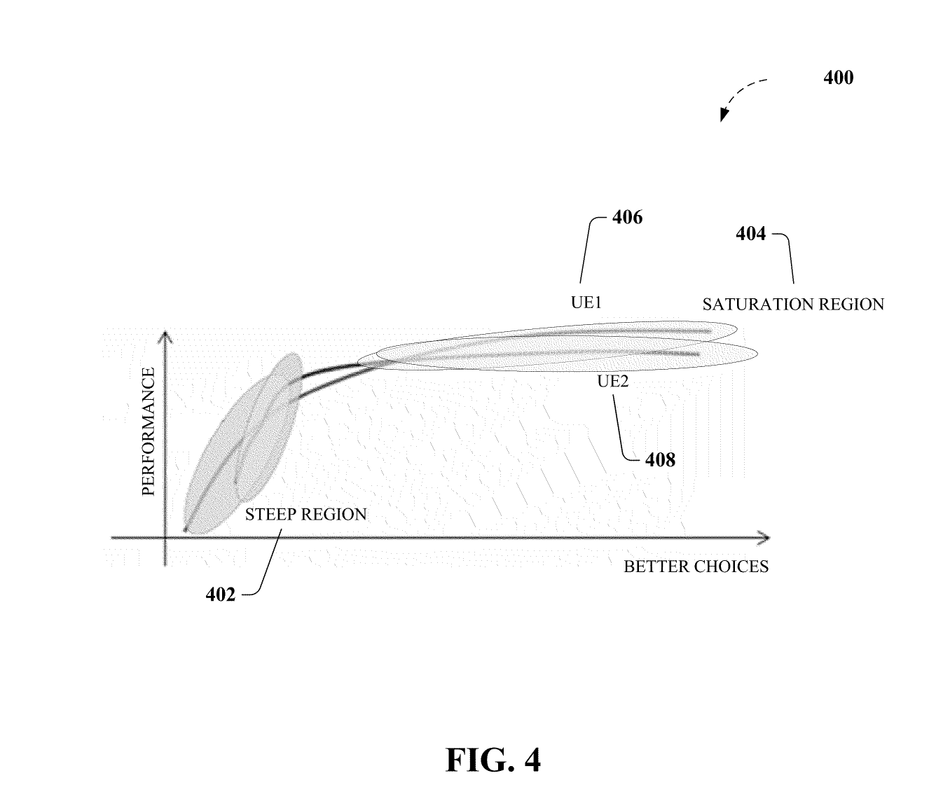

For example, FIG. 4 depicts a performance cumulative distribution function (CDF) 400 in an example wireless network. Accordingly, FIG. 4 illustrates the basic idea of a CDF curve of UE 106 performance regarding different SAS allocation, where it is believed that wireless performance becomes saturated. In this context, saturation is intended to refer to the phenomena that, while performance may be slightly improved given more cooperation or better resource choice, there exists a region where better choices may only offer diminishing returns. Thus, instead of wasting effort and resources (e.g., costs, allocation delay, etc.) to enhance performance of a particular UE 106, it may be worthwhile to schedule other UEs 106 by using particular choices of behavior 304 and RB 302 selection.

FIG. 4 also reveals another interesting trend. For example, it can be observed that performance of a particular UE 106 increases greatly (e.g., compared to saturation region) when a special SAS is allocated toward that particular UE 106. As an example, it can be understood that the steep increase (e.g., in the interesting region or steep region 402) can be caused by allocating an accurate serving cell (e.g., one of one or more eNBs 104) or a proper access behavior 304. For instance, it can be further understood that allocating the strongest cell (e.g., a particular eNB 104) for a particular UE 106 as a serving cell can increase the serving power and/or reduce the interference power, for example, as further described herein regarding FIG. 6, for example. Additionally, the saturation region 404 and steep region 402 can be different for each UE 106 as depicted in FIG. 4 for UE1 (406) and UE2 (408), for example.

Thus, instead of checking all SAS allocations and determining an optimization point in an exhaustive search, various non-limiting implementations of the disclosed subject matter can determine one or more allocations by employing knowledge or observation of those two regions (saturation region 404 and steep region 402) as depicted in FIG. 4. For instance, FIG. 5 illustrates a functional block diagram 500 of a multi-slope identification and scheduling algorithm (e.g., a two-slope identification 502 and scheduling algorithm 504, etc.) that facilitates Cloud-based RRM 202, as described herein. As an example, in various non-limiting implementations, properties regarding those regions (e.g., saturation region 404 and steep region 402) can be identified and can be used in a multi-slope scheduling algorithm (e.g., a two-slope scheduling algorithm, etc.) that can be employed to facilitate efficient Cloud-based RRM 202. As a further non-limiting example, a slope for a steep region 402 can be referred to herein and identified as a dominate factor (DF) 506, and its value can be determined as a first priority, in various non-limiting embodiments. The slope of a saturated region 404 can be referred to herein and identified as a degree of freedom (DoF) 508, and its slope value can be determined as a second priority, in further non-limiting embodiments. Further elaboration of such priorities, their respective determinations, and associated scheduling priorities and related components (e.g., eNB 104, RB 302, behavior 304, etc.) is further described below.

As another non-limiting example regarding DF 504 identification to facilitate SAS allocation 510, in the steep region 402 as exemplified in FIG. 4, the steep condition can be formulated by a slope, with its value calculated as a performance difference divided by a SAS difference. SAS difference can refer to many different components that can be used for constructing different SAS. For example, referring again to FIG. 4, SAS1 can be constructed by (eNB1, RB1) and SAS2 can be constructed by (eNB2, RB1), for example, as depicted in FIG. 3. Thus, it can be understood that the difference between SAS1 and SAS2 would be one (e.g., corresponding to the difference in SAS components eNB 104, etc.). Accordingly, a steep slope can be interpreted as a condition where a special SAS can increase performance significantly as compared with other SAS in a particular region. As a non-limiting example, a special SAS can be different from other SASs by only one component (e.g., a different eNB 104, a different RB 302, a different behavior 304, etc.), such that the steep slope's horizontal value is one. In various non-limiting implementations, such a condition is referred to herein as that component being a dominate factor or DF 506, for that UE 106 to achieve a particular level or threshold of performance (e.g., a particular predetermined level or threshold of performance, etc.). As a result, if a UE 106 can be allocated with that component (e.g., a different eNB 104, a different RB 302, a different behavior 304, etc., that results in the special SAS), the performance can be guaranteed to the particular level or threshold of performance no matter how remaining components would be used to construct a SAS, according to various aspects as described herein.

Moreover, a particular SAS having a more steep slope (e.g., slope's horizontal value is greater than one, etc.) indicates that the DF 506 can potentially provide more substantial gains for the UE 106 associated with the particular SAS. As a result, in various non-limiting implementations of the disclosed subject matter, a CS 102 can be employed to identify one or more steep regions 402 to get a dominate factor, or DF 506, and/or calculate respective slopes. Note that, a first slope value, φ, can be a priority, where a high value can be used to infer that a UE 106 has a higher priority to get that dominate factor, or DF 506, during scheduling.

In a further non-limiting example regarding DoF 508, in a saturation region 404, another slope can be formulated. A gently sloping region (e.g., saturation region 404, etc.) can be understood to indicate that the performance would not change substantially when allocating with different SAS (e.g., by constructing with different components). As used herein, the total numbers of SAS within the saturated region can be referred to as degree of freedom, as described above. A more gently sloping region can be understood to indicate that a UE 106 would have more DoF (e.g., more SAS choices) 508. Consequently, the urgency to construct a SAS for that UE 106 via an example CS 102 can be understood to be relatively low, according to various non-limiting aspects, relative to allocating the resources for UE 106 regarding DF 506. As a result, a second slope value, ω, can be another priority, where a high value can be used to infer that a UE 106 has a lower priority to allocate remaining components (e.g., one or more eNBs 104, one or more RBs 302, one or more behavior 304s, etc.) during scheduling.

Accordingly, to identify the multiple regions and priorities (e.g., steep region 402 and gently sloping region, or saturation region 404, corresponding to DF 506 and DoF 508, respectively, etc.), various non-limiting embodiments can employ statistics identification. For instance, for a set of UEs 106, a CS 102 can determine, calculate, record, and/or store performance calculations for possible SAS allocations. After calculating, a CS 102 can employ information associated with CDF curves (e.g., such as in the example CDF curve depicted in FIG. 4, etc.) to facilitate SAS 510 allocation.

Thus, in further non-limiting implementations, various thresholds can be predefined to facilitate determining DF 506 and DoF 508. For instance, in a non-limiting implementation employing an example CS 102 as described herein, three predetermined thresholds whose value can be represented by variables, A, B, and C, can be pre-defined. In a non-limiting example, if any slope value is larger than A, then it can be identified as a DF 506. In other non-limiting examples, B can be treated as a saturated level or a predetermined level or threshold of performance (e.g., an 80% performance level, etc.), and the performance curve can be inspected after reaching B. In yet other non-limiting examples, if any slope value is smaller than (1−B)/C, then it can be identified as a DoF 508. If an example CS 102 does not find any DF 506 or DoF 508 following these checks, then both DF 506 and DoF 508 can be assigned with 0, according to further non-limiting aspects. Thus, in non-limiting embodiments employing statistics identification, an example CS 102 can perform one or more threshold determinations as described herein regarding one or more UEs 106 to facilitate determining corresponding DF 506 and DoF 508.

FIG. 6 illustrates an example environment 600 depicting Reference Signal Received Power (RSRP) 602 as a function of UE 106 location with respect to two eNBs 104 (e.g., eNB1 (604) and eNB2 (606)). It is anticipated that computational complexity for a CS 102 employing statistics identification as described above can be substantial. Accordingly, further non-limiting implementations employing an example CS 102 can provide methods for omitting partial unnecessary calculations. Thus, in further non-limiting implementations involving channel gain identification, such implementations can omit partial unnecessary calculations, for example, based in part on receiving sensing results 512 (e.g., sensing results 512 from one or more UEs 106 such as one or more signals or data associated with received power at one or more UEs 106 from one or more eNBs 104, etc.). It is understood that UEs 106 having different locations can have varying respective channel gains from various eNBs 104, similar to that depicted in FIG. 6 for RSRP. Thus, access behavior 304 can be further decided, accordingly. It should be understood that RSRP as depicted in FIG. 6, which could be measured by UE 106 directly, is not equivalent to actual channel gain, which depends on transmission power of an eNB 104, and for which transmission power for different types of access nodes can vary in HetNets. Accordingly, while the term “channel gain” is used to describe various aspects of the subject disclosure, it can be appreciated that “channel gain,” in practice, can refer to sensing results 512 (e.g., sensing results 512 from one or more UEs 106 such as one or more signals or data associated with received power at one or more UEs 106 from one or more eNBs 104, etc.).

As an example, FIG. 6 depicts that, when UE1 (608) is very close to an eNB 104 (e.g., eNB1 (604)), conventionally, the best SAS would always be strongest eNB 104 (e.g., eNB1 (604)) to perform unique access. In addition, for UE2 (610), interference from eNB2 (606) would be expected to be increased, relative to UE1 (608), and it would be better to perform coordinated scheduling among eNB 1 (604) and eNB2 (606), while the performance would be enhanced by reducing the transmission power of eNB2 (606). Moreover, because both eNB1's and eNB2's RSRP (e.g., 612 and 614, respectively) is very similar but not strong enough for UE3 (616), joint transmission from eNB1 (604) and eNB2 (606) can be preferred.

Thus, in non-limiting implementations, through observations, speculations, and/or inferences, an example CS 102 can identify and/or infer potential steep 402 and gently sloping region 404 occurrences, from which, an example CS 102 can then perform checking on those regions as a subset of computations instead of performing such computations for all compositions, according to various aspects. For example, if an example CS 102 determines a channel gain or received power for a respective UE 106 and eNB 104 pair is much larger than for other pairings, an example CS 102 can calculate performance using the one eNB 104 as a unique serving cell for the particular UE 106 and can compare the associated performance to the performance using another relatively strong eNB 104 as a unique serving cell, according to further non-limiting aspects. Thus, in various non-limiting implementations, if the performance difference is larger than a defined steep slope (e.g., one whose slope value is larger than A as described above regarding FIGS. 4-5, etc.), for example, then DF 506 can be inferred as verified (e.g., the DF 506 for that UE 106 would be for allocating that strongest eNB 104).

DoF 508 identifications can also be derived by quickly inspecting partial channel gains or received power, by checking on those regions as a subset of computations instead of performing such computations for all compositions, according to further non-limiting aspects. In general, it is understood that performance of a UE 106 can become saturated by allocating SAS using strong channel gains or received power as serving cells. Therefore, in further non-limiting implementations, performance provided by one or more of a first, a second, and/or a third strong eNB 104, uniquely or cooperatively, can be determined, and a search for maximum and minimum performance can be conducted. Accordingly, DoF 508 can be identified, for instance, by comparing performance differences among the maximum and minimum performance with a predetermined value for the gently sloping region 404. Thus, in various non-limiting implementations, if the performance difference is smaller than the predetermined value, then it can be inferred that DoF has been identified and an associated value can be recorded and/or stored as ω.

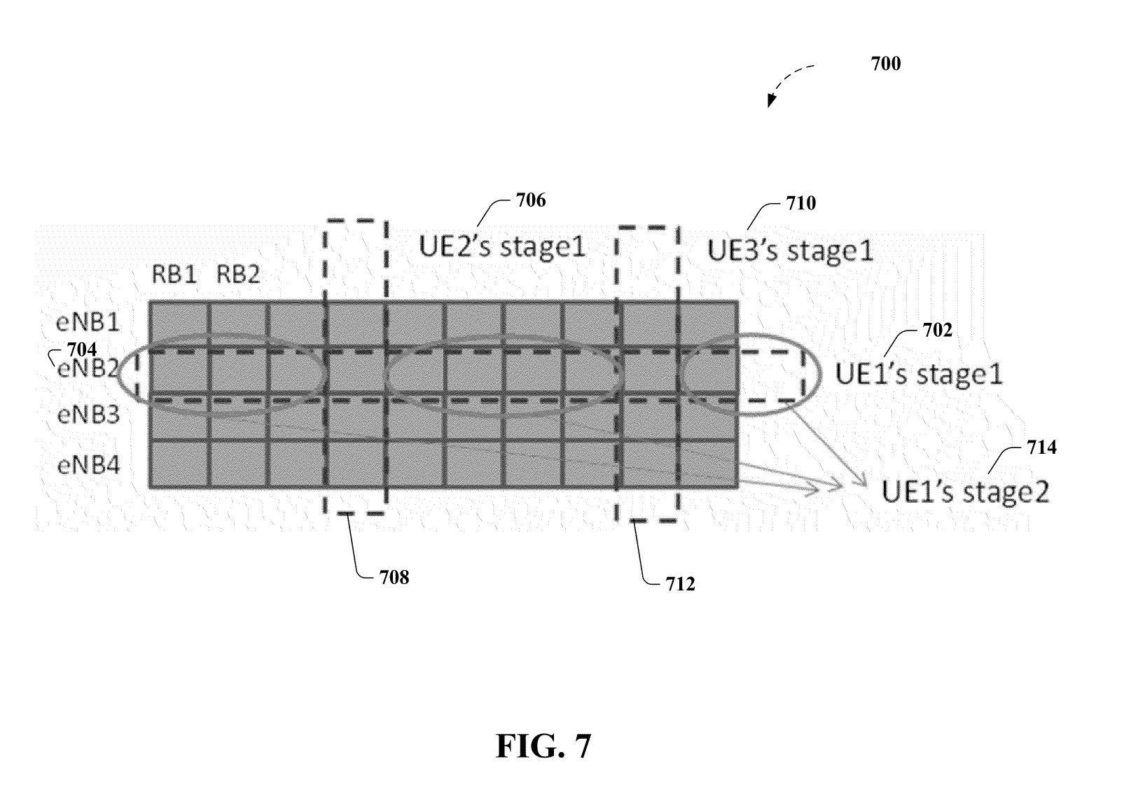

FIG. 7 demonstrates an example multi-slope scheduling (e.g., two-slope scheduling) 700, in which overall SAS 510 scheduling can be understood as a selection of dimensions in a two dimensional (2-D) space, where a horizontal dimension can be RB 302 allocation and a vertical dimension can be an eNB 104 allocation. Accordingly, in various non-limiting implementations of the disclosed subject matter, after identifying the two priorities (e.g., DF 506 and DoF 508), two-slope scheduling can be employed. According to various non-limiting aspects, two-slope scheduling can refer to SAS 510 scheduling divided into two stages, where one slope (e.g., priority) can be employed in each scheduling stage, respectively. For instance, it can be understood that a SAS can be constructed by three components (eNB 104, RB 302, and behavior 304). In a non-limiting aspect, access behavior 304 can be function of the number of eNBs 104. As a result, in further non-limiting implementations, SAS 510 allocation can be reduced to a joint selection of eNB 104 and RB 302 (e.g., selection of a horizontal dimension, RB 302 allocation, and a vertical dimension, eNB 104 allocation).

For instance, in a first stage, CS 102 can sequentially allocate associated components (e.g., an eNB 104, a set of eNBs 104, an RB 302, etc.) to a UE 106 with its DF 506 priority, in various non-limiting implementations. However, it can be understood that some constraints can be appropriate based on various considerations. For example, it can be understood that the opportunities for allocating an eNB 104 cannot exceed the number of RBs (e.g., an eNB 104 has finite RBs 302 for a given frame of reference). As a further example, it can be understood that the opportunities for allocating RB 302 cannot exceed the number of eNBs 104 (e.g., a RB 302 can be associated with n eNBs 104 as depicted in FIG. 3), and that one RB 302 in a particular eNB 104 can be allocated only once.

Thus, in various non-limiting implementations, if one of the constraints were met during allocation for a UE 106, a CS 102 can postpone that UE's 106 allocation until the end of the first stage for all UE 106. Accordingly, a CS 102 can then select a best choice among the remaining eNBs 104 or RBs 302 based on the performance to finalize the first stage allocation for that UE 106 (e.g., the UE 106, for which, the tentative allocation met a constraint). In a second stage, a CS 102 can allocate a remainder of components to a UE 106 based on its DoF 508 priority, according to further non-limiting aspects. As a non-limiting example, the remainder of components can be a SAS without DF 506 components (e.g., if DF 506 is an eNB 104, then the remainder component is a RB 508). In further non-limiting aspects, selection of a remainder component can rely on the candidates without being assigned during first stage. As such, in various non-limiting implementations, a CS 102 can perform SAS allocation from those candidates according to the performance and DoF 508 priority.

For example, referring again to FIG. 7, during an example non-limiting first stage, UE1's (702) DF 508 is eNB2 (704), UE2's DF 508 is RB4 (708), and UE3's (710) DF 508 is RB9. Assuming UE2 (706) and UE3 (710) have lower priority than UE1 (702), an example CS 102 can allocate eNB2 (704) as remainder components for UE1 (702) SAS during an example second stage (e.g., UE1's (702) tentative allocation of eNB2 (704) met a constraint during first stage, and thus, allocating eNB2 (704) is postponed until DoF 508 priority is considered). Accordingly, at UE1's (702) second stage 714, the candidates for UE1 (702) would be RB1-RB3, RB5-RB8, and RB10 associated with eNB2 (704). Thus, in a particular non-limiting aspect, a CS 102 can select a set of RB 302 with best performance to allocate to the UE1 (702), based on the two stage, two-slope scheduling, where it is expected that various non-limiting implementations employing two-slope scheduling can provide a particular level or threshold of performance while substantially reducing processing time.

Another non-limiting illustration is provided to further understand the provided examples. For instance, assume a UE1 (702) access system 1 having components, [A1, B1, C1], and an access system 2 having components, [A1, B1, Cx]. It is noted that the components of system 1 and system 2 for UE1 (702) differs by the component C1. If it is noted that the performance difference between system 1 and system 2 for UE1 (702) is the largest encountered for UE1 (702), this performance difference could be assigned as the first scheduling priority for UE1 (702), with C1 as the corresponding component (e.g., an eNB 104, a set of eNBs 104, an RB 302, etc.), which can be assumed to be a specific eNB 104. Likewise, assume a UE2 (706) access system 1 having components, [A1,B1,C1], and access system 2 having components, [A1,Bx,C1]. It is noted that the components of system 1 and system 2 for UE2 (706) differs by the component B 1. If it is noted that the performance difference between system 1 and system 2 for UE2 (706) is the largest encountered for UE2 (706), this performance difference could be assigned as the first scheduling priority for UE2 (706), with B1 as the corresponding component (e.g., an eNB 104, a set of eNBs 104, an RB 302, etc.), which can be assumed to be a specific RB 302. Thereafter, an example CS 102 can compare UE1 (702) first scheduling priority and UE2 (706) first scheduling priority. If example CS 102 determines that UE2 (706) first scheduling priority is larger than that for UE1 (702), then example CS 102 can allocate component B1 to UE2 (706), first, where (A1,C1) are remaining components (e.g., an eNB 104, a set of eNBs 104, an RB 302, etc.), which can be a specific eNB 104 with a specific or selected behavior 304). As a result, it can be understood that each UE 106 DF 508 could be associated with any of a number a different kinds of component (e.g., an eNB 104, a set of eNBs 104, an RB 302, etc.).

FIG. 8 depicts a functional block diagram 800 of a two-slope identification and scheduling algorithm employing clustering and/or grouping that facilitates Cloud-based RRM 202. In order to further reduce computational complexity, various non-limiting implementations of the disclosed subject matter can be employed to a group and/or cluster of UEs 106, where members of the cluster can be determined to have similar channel conditions (e.g., similar conditions of channel fading, interference condition, and/or other criteria, and/or combinations thereof, etc.), and where members of the group can be determined such that, for respective transmissions, the members of the group do not interfere with each other. As a non-limiting example, clustering and/or grouping can be employed by various non-liming implementations of an example CS 102. For instance, a cluster can be defined as two or more UEs 106 having identical access behavior (e.g., same DF 506 associated with steep performance increases, etc.). In other words, a different cluster can have different scheduling criteria and different DF 506, in a non-limiting aspect. In another non-limiting aspect, a group can be defined as two or more UEs 106 that can be allocated a set of identical RB 302, where the UEs 106 belong to different cluster. It can be understood that, because members of a group do not interfere with each other, an example CS 102 can decouple them when performing scheduling.

In a further non-limiting aspect, grouping and/or clustering can be performed according to a UE's 106 location. In yet another non-limiting aspect, one or more predetermined levels (e.g., three predetermined levels, etc.) can be specified to categorize UEs 106. In various non-limiting implementations of the disclosed subject matter, by comparing the strongest channel gain (e.g., sensing results 512, received power, etc.) with one or more of the one or more predetermined levels (e.g., three predetermined levels, etc.), a CS 102 can cluster UEs 106 into one or more clusters (e.g., three clusters, etc.), and/or can identify DF 506 for a cluster as further described herein. In a non-limiting example, a cluster can be further divided into a one or more groups. Accordingly, UEs 106 in the same group can be served by different eNBs 104, for instance, with identical RB(s). Thus, in various non-limiting embodiments of the disclosed subject matter, after clustering and grouping, a CS 102 can identify DF 506 and/or DoF 508 per cluster, perform two-slope scheduling for each group, etc. FIG. 8, therefore, depicts a functional block diagram 800 of a two-slope identification and scheduling algorithm employing clustering and grouping 802, where clustering and grouping 802 of UEs 106 can be performed according to sensing results 512. As described, CS 102 can perform DF 506 and/or DoF 508 identification and two-slope scheduling, for which, based in part on convergence of results, CS 102 can allocate corresponding SAS to the respective clusters and/or groups 804. As described above, a conventional CS 102 can be configured to try all possible SAS allocations among every UE 106, such as an exhaustive search, such that the attendant computational complexity can degrade Cloud-based RRM 202 performance. However, according to one or more of non-limiting aspects of the disclosed subject matter, an example CS 102 configured according to various aspects as described herein can identify DF 506 and/or DoF 508 for one or more clusters and/or groups to provide fast response to changing environments to facilitate utilizing the diversity of a HetNet 204.

FIG. 9 illustrates an example non-limiting flow diagram of methods 900 for performing aspects of embodiments of the disclosed subject matter. For instance, referring to FIG. 9, methods 900 for network access allocation can facilitate receiving, by a system comprising a processor (e.g., an example CS 102, etc.), information associated with one or more channel conditions (e.g., channel gain, received power, other channel statistics, etc.) between one or more network nodes of an access system (e.g., one or more eNBs 104, etc.) and one or more communication device (e.g., one or more user device or equipment, or UE 106, etc.), as described herein. As a non-limiting example, as described above regarding FIGS. 4-7, for example, non-limiting implementations involving receiving information associated with the one or more channel conditions, such as channel gain, received power, etc., where such implementations can omit partial unnecessary calculations, for example, based in part on receiving sensing results 512 (e.g., sensing results 512 from one or more UEs 106), etc. Thus, in a further non-limiting implementation, at 902, receiving information associated with the one or more channel conditions (e.g., channel gain, received power, other statistics, etc.) can comprise receiving information associated with signal strength from a set of eNB devices (e.g., one or more eNBs 104, etc.) that are proximate to the one or more communication devices (e.g., one or more user device or equipment, or UE 106, etc.).

In addition, as described above, methods 900 can further comprise, at 904, identifying, by the system (e.g., an example CS 102, etc.), one or more scheduling priorities based on the information associated with the one or more channel conditions (e.g., channel gain, received power, other statistics, etc.) between one or more network nodes of an access system (e.g., one or more eNBs 104, etc.) and one or more communication devices (e.g., one or more user device or equipment, or UE 106, etc.), as described herein. In other non-limiting implementations, at 904, the identifying one or more scheduling priorities can also comprise identifying one or more of the scheduling priorities based on grouping and/or clustering 802 the communication device (e.g., one or more user device or equipment, or UE 106, etc.) with one or more other communication devices (e.g., one or more user device or equipment, or UE 106, etc.) regarding the information associated with the one or more channel conditions, as further described herein. Moreover, in further example implementations, grouping and/or clustering 802 can also comprise grouping based on one or more of the information associated with the one or more channel conditions, a location associated with the one or more communication devices (e.g., one or more user device or equipment, or UE 106, etc.) or the one or more other communication devices (e.g., one or more user device or equipment, or UE 106, etc.), or a number of available RBs 302 for the one or more eNB devices (e.g., one or more eNBs 104, etc.).

In addition, example implementations of methods 900 can also comprise, at 906, determining, by the system (e.g., an example CS 102, etc.), a performance difference between a first determined performance associated with the components (e.g., eNB 104, RB 302, and/or behavior 304) of the access system (e.g., one or more eNBs 104, etc.) and a second determined performance associated with a set of other components of the access system (e.g., one or more eNBs 104, etc.), as further described herein, for example regarding FIGS. 4-7 (e.g., regarding a steep slope region 402, a saturation region 404, DF 506, DoF 508, etc.). Accordingly, in a further non-limiting example, at 906, determining a performance difference can comprise determining a performance difference based on one or more of a throughput difference, a capacity difference, or an energy consumption difference associated with one or more of the communication devices (e.g., UE 106) or the one or more one network nodes (e.g., one or more eNBs 104, etc.).

Moreover, other example implementations of methods 900 can also comprise, at 908, assigning, by the system (e.g., an example CS 102, etc.), the performance difference as a first scheduling priority of the one or more scheduling priorities, in response to the performance difference being determined to be greater than or equal to a first predetermined threshold. For instance, as described above regarding FIG. 5, for example, in a non-limiting implementation employing an example CS 102 as described herein, three predetermined thresholds whose value can be represented by variables, A, B, and C, can be pre-defined. In a non-limiting example, if any slope value is larger than A, then it can be identified as a DF 506. In other non-limiting examples, B can be treated as a saturated level or a predetermined level of performance (e.g., an 80% performance level, etc.), and the performance curve can be inspected after reaching B. In yet other non-limiting examples, if any slope value is smaller than (1−B)/C, then it can be identified as DoF 508.

If CS 102 does not find any DF 506 or DoF 508 following these checks, then both DF 506 and DoF 508 can be assigned with 0, according to further non-limiting aspects. Thus, in non-limiting embodiments employing statistics identification, an example CS 102 can perform one or more threshold determinations as described herein regarding one or more UEs 106 to facilitate determining corresponding DF 506 and DoF 508. Accordingly, still other example implementations of methods 900 can also comprise, at 910, assigning, by the system (e.g., an example CS 102, etc.), the performance difference as a second scheduling priority of the one or more scheduling priorities, in response to the first determined performance being determined to be greater than or equal to a second predetermined threshold and the performance difference being determined to be less than or equal to a third predetermined threshold, as described above.

In yet other example implementations of methods 900 can also comprise, at 912, allocating (e.g., sequentially allocating), by the system (e.g., an example CS 102, etc.), components (e.g., eNB 104, RB 302, and/or behavior 304) of the access system (e.g., one or more eNBs 104, etc.) to the communication device (e.g., one or more user device or equipment, or UE 106, etc.) based on the one or more scheduling priorities, as described herein. As a non-limiting example, as described above, it is understood that UEs 106 having different locations can have varying respective channel gains or received power from various eNBs 104, and access behavior 304 can be further decided, accordingly. For instance, as further described herein, regarding FIGS. 3, 7-8, etc., for example, determination of a SAS can further comprise behavior 304 selection and resource block (RB) 302 selection. Thus, it can be understood that a SAS can be constructed by three components (eNB 104, RB 302, and behavior 304). In a non-limiting aspect, access behavior 304 can be function of the number of eNBs 104. As a result, in further non-limiting implementations, SAS 510 allocation can be reduced to a joint selection of eNB 104 and RB 302 (e.g., selection of a horizontal dimension, RB 302 allocation, and a vertical dimension, eNB 104 allocation) as described above regarding FIG. 7, for example.

Thus, in still further example implementations of methods 900, at 912, the sequentially allocating can comprise allocating one or more components of the components (e.g., eNB 104, RB 302, and/or behavior 304) to the communication device based on the first scheduling priority (e.g., by sorting the first scheduling priority associating with UEs 106 and allocating the corresponding component in the sorted order, etc.) and allocating remaining components (e.g., eNB 104, RB 302, and/or behavior 304) of the components to the communication device (e.g., one or more user device or equipment, or UE 106, etc.) based on the second scheduling priority (e.g., allocating corresponding remaining components in reverse order of second priority, etc.). As a non-limiting example, at 912, allocating one or more components (e.g., eNB 104, RB 302, and/or behavior 304) based on the first scheduling priority can include determining a component (e.g., one of an eNB 104, a RB 302, and/or a behavior 304) that differs between components associated with the first determined performance and the set of other components associated with the second determined performance, as described above, regarding FIG. 7, for example. In another non-limiting example, at 912, allocating one or more components of the access system (e.g., one or more eNBs 104, etc.) to the communication device (e.g., one or more user device or equipment, or UE 106, etc.) can also include sorting the first scheduling priority for the communication device (e.g., one or more user device or equipment, or UE 106, etc.) and sequentially allocating the one or more components of the access system in order, sorting the second scheduling priority for the communication device and sequentially allocating a set of remaining components in reserve order, and so on, as further described herein. Moreover, sequentially allocating one or more components of the access system (e.g., one or more eNBs 104, etc.) to the communication device (e.g., one or more user device or equipment, or UE 106, etc.) can also include assigning one or more of a RB 302, an eNB 104, or a selected access behavior 304 associated with the communication device. In addition, in yet other example implementations of methods 900, at 912, the sequentially allocating can comprise allocating one or more resource blocks (e.g., RBs 302) of an eNB device (e.g., eNB 104, etc.) for communication by the communication device (e.g., one or more user device or equipment, or UE 106, etc.) in a selected behavior (e.g., behavior 304).

FIG. 10 illustrates an example non-limiting flow diagram of methods 1000 for performing aspects of embodiments of the disclosed subject matter. For instance, referring to FIG. 10, methods 1000 for operating a software-defined radio device (e.g., one or more user device or equipment, or UE 106, etc.) according to various aspects of the disclosed subject matter can facilitate, at 1002, transmitting (e.g., via one or more user device or equipment, or UE 106, etc.) information associated with one or more channel conditions (e.g., channel gain, received power, other channel statistics, etc.) between a network node of an access system (e.g., one or more eNBs 104, etc.) and the radio device to a network controller comprising an access allocation system (e.g., an example CS 102, etc.), as described herein, regarding FIGS. 4-7, for example.

In another non-limiting example, methods 1000 for operating a software-defined radio device (e.g., one or more user device or equipment, or UE 106, etc.) according to various aspects of the disclosed subject matter can facilitate, at 1004, receiving an access allocation (e.g., SAS 510, etc.) from the network controller, wherein the access allocation (e.g., SAS 510, etc.) can comprise components (e.g., eNB 104, RB 302, and/or behavior 304) of the access system (e.g., one or more eNBs 104, etc.), based on one or more scheduling priorities determined by the access allocation system (e.g., an example CS 102, etc.), based on a performance difference between a first determined performance associated with the components (e.g., eNB 104, RB 302, and/or behavior 304) and a determined second performance associated with a set of other components (e.g., eNB 104, RB 302, and/or behavior 304) of the access system (e.g., one or more eNBs 104, etc.) or of one or more other network nodes of the access system (e.g., one or more eNBs 104, etc.). In non-limiting examples of methods 1000, at 1004, methods 1000 can comprise receiving an access allocation including allocation of one or more RBs 302 of one or more eNB devices (e.g., one or more eNBs 104, etc.) based on a first scheduling priority of the one or more scheduling priorities and an allocation of one or more remaining RBs 302 based on a second scheduling priority, wherein the first and second scheduling priorities are based on the performance difference, as further described above regarding FIG. 9, for example. It can be understood that various non-limiting implementations of the subject disclosure (e.g., methods 900, methods 1000, etc.) can comprise dynamic access allocation based in part on a changing performance objective, information related to access systems changing (e.g, variation in quantity, performance, location, etc. associated with eNBs 104, UEs 106, etc., changes in channel conditions, and so on), etc.

In still other non-limiting examples of methods 1000, at 1004, methods 1000 can comprise receiving an access allocation (e.g., SAS 510, etc.) including components (e.g., eNB 104, RB 302, and/or behavior 304) allocated to a cluster of devices (e.g., one or more user device or equipment, or UE 106, etc.), such as described above regarding FIG. 8, for example, comprising the software-defined radio device (e.g., one or more user device or equipment, or UE 106, etc.) and one or more other communication devices (e.g., one or more user device or equipment, or UE 106, etc.) based on the information associated with the one or more channel conditions (e.g., channel gain, received power, other channel statistics, etc.), a location associated with the software-defined radio device (e.g., one or more user device or equipment, or UE 106, etc.) or the one or more other communication devices (e.g., one or more user device or equipment, or UE 106, etc.), signal strength from a set of eNBs 104 that are proximate to the software-defined radio device (e.g., one or more user device or equipment, or UE 106, etc.) or the one or more other communication devices (e.g., one or more user device or equipment, or UE 106, etc.), or a number of available RBs 302 for the eNB 104. In addition, in further example implementations of methods 1000, at 1004, methods 1000 can comprise receiving an access allocation (e.g., SAS 510, etc.) including an access allocation based on the first scheduling priority of the one or more scheduling priorities, where the performance difference is greater than or equal to a first threshold, and based on the second scheduling priority of the one or more scheduling priorities, where a first determined performance associated with the components (e.g., eNB 104, RB 302, and/or behavior 304) is greater than or equal to a second threshold and the performance difference is less than or equal to a third threshold, for example, as described above regarding FIG. 9, etc.

In further example implementations of methods 1000, at 1006, methods 1000 can comprise communicating information (e.g., one or more packets or other data or signals representing voice information, textual information, the visual information, etc.) to the one or more network nodes of the access system (e.g., one or more eNBs 104, etc.) based on the access allocation (e.g., SAS 510, etc.).

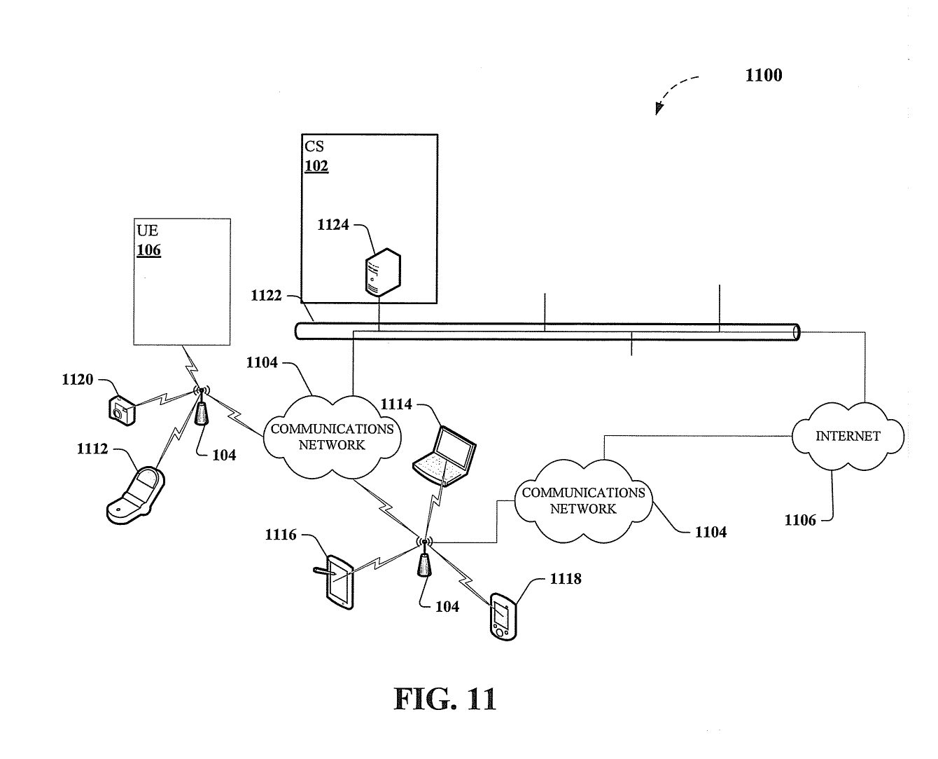

In view of the example embodiments described supra, devices and systems that can be implemented in accordance with the disclosed subject matter will be better appreciated with reference to the flowcharts of FIGS. 11-17. While for purposes of simplicity of explanation, the example devices and systems are shown and described as a collection of blocks, it is to be understood and appreciated that the claimed subject matter is not limited by the order, arrangement, and/or number of the blocks, as some blocks may occur in different orders, arrangements, and/or combined and/or distributed with other blocks or functionality associated therewith from what is depicted and described herein. Moreover, not all illustrated blocks may be required to implement the example devices and systems described hereinafter. Additionally, it should be further understood that the example devices and systems and/or functionality disclosed hereinafter and throughout this specification are capable of being stored on an article of manufacture to facilitate transporting and transferring such methods to computers, for example, as further described herein. The terms computer readable medium, article of manufacture, and the like, as used herein, are intended to encompass a computer program accessible from any computer-readable device or media such as a tangible computer readable storage medium.

### Example Systems and Devices

FIG. 11 illustrates an overview of an example computing environment 1100 suitable for incorporation of embodiments of the disclosed subject matter. For example, computing environment 1100 can comprise wired communication environments, wireless communication environments, and so on. As a further example, computing environment 1100 can further comprise one or more of wireless access components, such as one or more eNBs 104, and/or one or more communications networks 1104, the Internet 1106, etc., for which an example user device for equipment, such as UE 106, etc., can be configured as any of a variety of devices (e.g., an example UE 106, devices 1112-1122, and so on) comprising an appropriately configured interface that facilitates Cloud-based RRM 202, such as described herein, for example, with reference to FIGS. 1-10, 12-14, etc.), or other functionality (e.g., browsers, clients, etc.) to communicate data and/or information over a communication medium (e.g., a wired medium 1122, a wireless medium, etc.) according to an agreed protocol, to facilitate communication of data and/or information associated UE 106 between and/or among one or more of CS 102 and/or one or more eNBs 104 and/or computing systems or devices associated therewith, such as computing systems or devices 1124, and so on (e.g., via an operating system, application software, device drivers, communications stacks, etc., which can perform such actions on behalf of such computing systems or devices).

Accordingly, computing environment 1100 can comprise a number of components and/or subcomponents to facilitate described functionalities according to various aspects of the disclosed subject matter, among other related functions. While various embodiments are described with respect to the components of computing environment 1100 and the further embodiments more fully described herein, one having ordinary skill in the art would recognize that various modifications can be made without departing from the spirit of the disclosed subject matter. Thus, it can be understood that the description herein is but one of many embodiments that may be possible while keeping within the scope of the claims appended hereto.

Additionally, while UE 106 is shown as a generic network capable device, which can comprise any of a variety of devices (e.g., devices 1112-1122, and so on), an example UE 106 is intended to refer to a class of network capable devices that can one or more of receive, transmit, store, etc., data and or information incident to various techniques of the disclosed subject matter directed to access allocation in HetNets as described herein. However, the discussion of the foregoing distinction is intended for illustration and not limitation. While for purposes of illustration, one or more of CS 102, eNB 104, and/or UE 106 are described as performing certain actions, it is to be understood that associated computing devices or systems (e.g., via an operating system, application software, device drivers, communications stacks, etc.) can perform such actions on behalf of such entities, and/or associated users, organizations, and so on.

Accordingly, an example UE 106 can comprise, without limitation, a cellular phone 1112, a laptop computer 1114, a tablet personal computer (PC) device 1116, and/or a personal digital assistant (PDA) 1118, or other mobile device, and so on connected to, and/or capable of being connected to, a network via eNB 104 and so on. As further examples, an example UE 106 can comprise such devices as a network capable camera 1120 and other such devices (not shown) as a pen computing device, wearable computing device, portable digital music player, home entertainment devices, network capable devices, appliances, kiosks, and sensors, and so on. It is to be understood that an example UE 106 can comprise more or less functionality than those example devices described above as the context requires and as further described herein in connection with FIGS. 1-10, 14-18, etc., for instance.

According to various embodiments of the disclosed subject matter, an example UE 106 can connect to other devices to facilitate accomplishing various functions as further described herein. In addition, an example UE 106 can connect via one or more communications networks 1104 to a wired network 1122 (e.g., directly, via the Internet 1106, or otherwise). Wired network 1122 (as well as communications network 1104) can comprise any number of computers, servers, intermediate network devices, and the like to facilitate various functions as further described herein. As a non-limiting example, wired network 1122 can comprise and/or be associated with other computing systems or devices (e.g., such as one or more appropriately configured computing devices associated with, operated by, or operated on behalf of wireless operators, etc.) as described above, that facilitates access allocation in HetNets as described herein.

In a further non-limiting example, wired network 1122 can comprise and/or be associated with computing systems or devices 1124 (e.g., one or more appropriately configured computing devices associated with, operated by, or operated on behalf of wireless operators, etc.) as described above, that facilitates functionality as described herein regarding an example CS 102. It can be appreciated that an example CS 102 and/or portions thereof can further comprise any number of intermediaries acting on behalf of CS 102, wireless operators, and/or other proprietors, to facilitate various functions as further described herein. In a further non-limiting example, an intermediary acting on behalf of an example CS 102 can store and/or provide access to data and/or information associated with or related to CS 102 and/or functionality associated therewith. Moreover, an example CS 102 can be further configured to perform any number of additional and/or complementary functions incident to functionalities as described above, regarding FIGS. 2-10, for example.

In addition, wired network 1122 or systems (or components) thereof can facilitate performing ancillary functions to accomplish various techniques described herein. For example, computing systems or devices associated with wired network 1122 can provide functions that facilitate authentication and/or authorization of an example UE 106 and/or users or organizations associated therewith, wireless operators, and/or others to CS 102, and vice versa, transmission of data and/or information associated with CS 102 (e.g., via an API, etc.) and/or other information associated with facilitating access allocation in HetNets, etc., as described above. Accordingly, in various non-limiting embodiments of the disclosed subject matter, computing environment 1100 can further comprise additional network components (not shown). For example, systems, devices, and/or components can be relatively simplistic and/or lacking certain features to facilitate various techniques of the disclosed subject matter. Thus, particular aspects of the disclosed subject matter can be facilitated by additional network components (not shown) in communication with the devices and/or other components of computing environment 1100.

Accordingly, computing environment 1100 can comprise further components (not shown) (e.g., authentication, authorization and accounting (AAA) servers, e-commerce servers, database servers, application servers, etc.) in communication with one or more of an example CS 102, computing systems or devices 1124 associated therewith, computing systems or devices associated with wireless operators, and/or an example UE 106, eNB 104, etc., to accomplish the desired functions, without limitation.

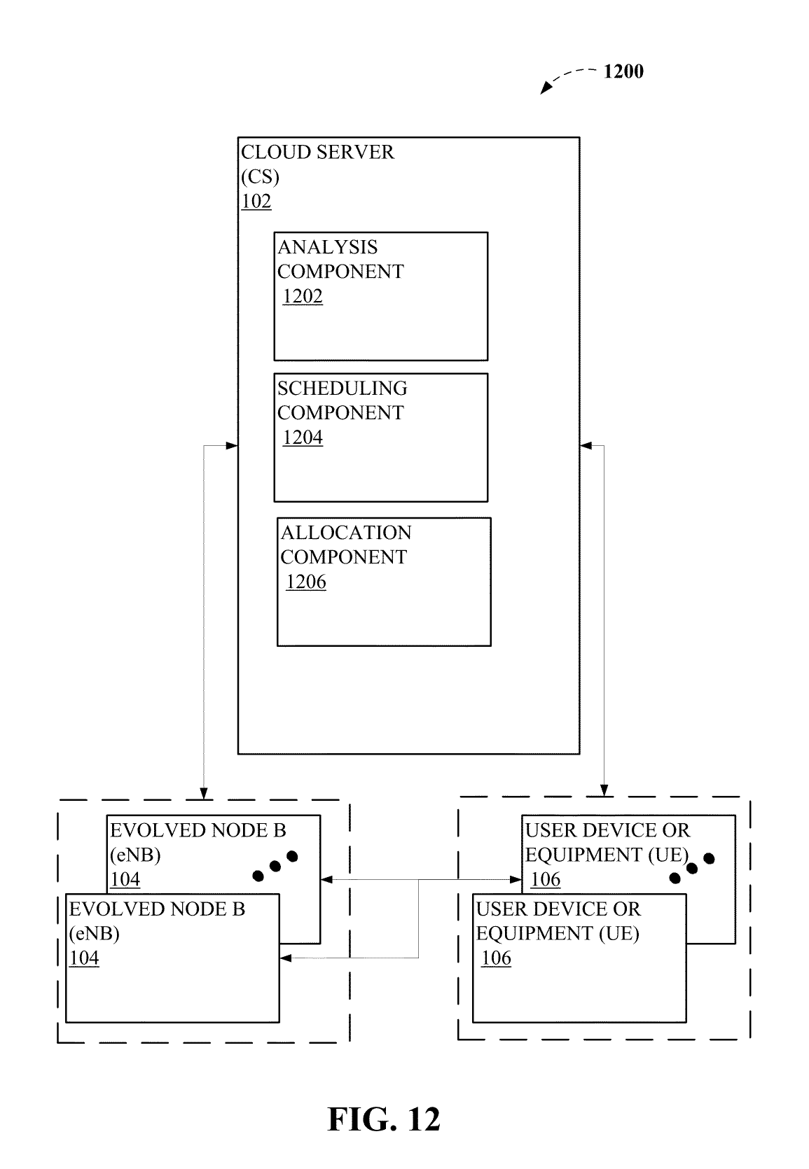

FIG. 12 depicts a functional block diagram illustrating example non-limiting devices or systems suitable for use with aspects of the disclosed subject matter. For instance, FIG. 12 illustrates example non-limiting devices or systems 1200 suitable for performing various aspects of the disclosed subject matter in accordance with an example CS 102 as further described herein. For example, as described above regarding FIGS. 1-2, an example operating environment such as depicted in FIG. 1 can comprise one or more of a cloud server, or CS 102, one or more evolved Node Bs, or eNBs 104, and/or one or more user equipment or device, or UE 106. As further described herein, in various embodiments of the disclosed subject matter, methods and architectures of SAS allocation for Cloud-based RRM are provided. By identifying special factors from sensing results from one or more UEs 106, such as described herein regarding FIGS. 5-6, and 8, and/or clustering UEs 106 with similar characteristic, such as described herein regarding FIG. 8, various non-limiting implementations of a CS 102 can prioritize and simplify SAS allocations for one or more UEs 106.

As depicted in FIG. 12, device or system 1200 comprising an example CS 102, or portions thereof, can comprise an analysis component 1202, etc. As further depicted in FIG. 12, CS 102 can also comprise a scheduling component 1204, an allocation component 1206, etc., either as described above, or as further described herein. In addition, device or system 1200 comprising an example CS 102, or portions thereof, can comprise one or more memories and/or storage components to store computer-executable components (e.g., one or more of an analysis component 1202, a scheduling component 1204, an allocation component 1206, and/or other complementary and/or ancillary components or subcomponents, etc.) and/or one or more processors communicatively coupled to the memory that facilitates execution of the computer-executable components, for example, as further described herein.

Thus, FIG. 12 illustrates an example non-limiting device or system 1200 suitable for performing various aspects of the disclosed subject matter. As described above with reference to FIG. 11, for example, various non-limiting embodiments of the disclosed subject matter can comprise more or less functionality than those example devices or systems described therein, depending on the context. In addition, a device or system 1200 as described can be any of the devices and/or systems as the context requires and as further described above in connection with FIGS. 1-11, for example. It can be understood that while the functionality of device or system 1200 is described in a general sense, more or less of the described functionality may be implemented, combined, and/or distributed (e.g., among network components, servers, databases, and the like), according to context, system design considerations, and/or marketing factors, and the like. For the purposes of illustration and not limitation, example non-limiting devices or systems 1200 can comprise one or more example devices and/or systems of FIG. 11, such as CS 102 (computing system 1124, etc.) as described herein, for example, or portions thereof.

According to further example implementations, device or system 1200 comprising an example CS 102, or portions thereof, can comprise analysis component 1202 as mentioned above. To that end, one or more processors can be associated with analysis component 1202 to facilitate functionality described herein. In a non-limiting example, device or system 1200 comprising an example CS 102, or portions thereof, can facilitate, among other things, analyzing information associated with one or more channel conditions between one or more network nodes of an access system (e.g., one or more eNBs 104, etc.) and a communication device (e.g., one or more user device or equipment, or UE 106, etc.), performing one or more analyses, determining results of the one or more analyses, and/or generate results, reports, inferences, and/or recommendations, compose and/or respond to requests or queries, etc. For instance, an example CS 102 comprising an analysis component 1202 can facilitate one or more analyses that can be employed to facilitate decision making (e.g., decision making via a manual, semi-automated, or fully automated process, according to a decision tree, a decision matrix, heuristics, inference, artificial intelligence, or other decision tool, or any combination, etc.) concerning information and/or data associated with CS 102, as described herein.

In other example implementations of CS 102 comprising analysis component 1202, CS 102 can facilitate clustering and/or grouping 802 the communication device (e.g., one or more user device or equipment, or UE 106, etc.) with one or more other communication devices (e.g., one or more user device or equipment, or UE 106, etc.) regarding the information associated with the one or more channel conditions (e.g., channel gain, received power, other channel statistics, etc.), and/or analyses thereof, based on one or more of the information associated with the one or more channel conditions (e.g., channel gain, received power, other channel statistics, etc.), a location associated with the communication device (e.g., one or more user device or equipment, or UE 106, etc.) or one or more other communication devices (e.g., one or more user device or equipment, or UE 106, etc.), a set of signal strengths from a set of eNB devices (e.g., one or more eNBs 104, etc.) that are proximate to the communication device (e.g., one or more user device or equipment, or UE 106, etc.) or the one or more other communication devices (e.g., one or more user device or equipment, or UE 106, etc.), and/or a number of available RBs 302 for the eNB 104.

It can be understood that CS 102 comprising analysis component 1202 can facilitate employing any of a number, type, and/or category of information, data, and/or attributes, associated with the one or more channel conditions, one or more eNBs 104, one or more UEs 106, CS 102, or otherwise, etc., to facilitate analyses of information and/or channel statistics, without limitation. In a further non-limiting example, analysis component 1202 can facilitate analyses regarding aggregate data (e.g., information regarding grouped, clustered, and/or otherwise aggregated information, whether related to channel conditions, or otherwise, etc.) for one or more eNBs 104, one or more UEs 106, and/or subsets thereof employing any of a number, type, and/or category of information, data, and/or attributes, associated with a channel (e.g., between one or more eNBs 104 and one or more UEs 106, or otherwise, etc., without limitation to system requirements such as device type (e.g., desktop, tablet, smartphone, etc.), operating system specification (e.g., brand/or type and version, such as Windows® 7, Android™ 3.0, etc.), device hardware or software specification (e.g., RAM, hard disk, Internet browser, etc.), and/or data, information, and/or attributes relating thereto, etc.

According to still further example implementations, device or system 1200 comprising an example CS 102, or portions thereof, can comprise scheduling component 1204 as mentioned above. To that end, one or more processors can be associated with scheduling component 1204 to facilitate functionality described herein. In a non-limiting example, device or system 1200 comprising an example CS 102, or portions thereof, can facilitate, among other things, identifying one or more scheduling priorities based on the information associated with the one or more channel conditions between one or more network nodes (e.g., one or more eNBs 104, etc.) and a communication device (e.g., one or more user device or equipment, or UE 106, etc.), as further described herein. In a further non-limiting example, device or system 1200 comprising an example CS 102, or portions thereof, can facilitate determining a performance difference between a first performance associated with the components (e.g., eNB 104, RB 302, and/or behavior 304) of the access system (e.g., one or more eNBs 104, etc.) and a second performance associated with a set of other components (e.g., eNB 104, RB 302, and/or behavior 304) of the access system or of one or more other network nodes of the access system (e.g., one or more eNBs 104, etc.), wherein the performance difference can comprise a difference in performance determined based on one or more of a throughput difference, a capacity difference, or an energy consumption difference associated with one or more of the communication device (e.g., one or more user device or equipment, or UE 106, etc.) or the one or more network nodes (e.g., one or more eNBs 104, etc.), as further described above, regarding FIGS. 5, 9, etc., for example.

In still further non-limiting examples, device or system 1200 comprising an example CS 102, or portions thereof, can facilitate assigning the performance difference as a first scheduling priority of the one or more scheduling priorities, for example, in response to the performance difference being determined to be greater than or equal to a first threshold, and/or assign the performance difference as a second scheduling priority of the one or more scheduling priorities, in response to a first determined performance associated with the components being determined to be greater than or equal to a second threshold and the performance difference being determined to be less than or equal to a third threshold, as further described above, regarding FIGS. 5, 9, etc., for example.

According to still further example implementations, device or system 1200 comprising an example CS 102, or portions thereof, can comprise allocation component 1206 as mentioned above. To that end, one or more processors can be associated with allocation component 1206 to facilitate functionality described herein. In a non-limiting example, device or system 1200 comprising an example CS 102, or portions thereof, can facilitate, among other things, sequentially allocating components (e.g., eNB 104, RB 302, and/or behavior 304) of the access system (e.g., one or more eNBs 104, etc.) to the communication device (e.g., one or more user device or equipment, or UE 106, etc.) based on the one or more scheduling priorities. In still further non-limiting examples, device or system 1200 comprising an example CS 102, or portions thereof, can facilitate allocating components (e.g., eNB 104, RB 302, and/or behavior 304) of the access system (e.g., one or more eNBs 104, etc.) to the communication device (e.g., one or more user device or equipment, or UE 106, etc.) and the one or more other communication devices (e.g., one or more user device or equipment, or UE 106, etc.) as a cluster and/or group 804 based on one or more of the one or more scheduling priorities. In addition, in other example implementations, device or system 1200 comprising an example CS 102, or portions thereof, can facilitate allocating one or more component of the access system (e.g., one or more eNBs 104, etc.) to the communication device (e.g., one or more user device or equipment, or UE 106, etc.) in order of the first scheduling priority and/or allocating at least one remaining component of the access system (e.g., one or more eNBs 104, etc.) in reverse order of the second scheduling priority. Still further non-limiting examples of device or system 1200 comprising an example CS 102, or portions thereof, can facilitate determining a component (e.g., one of an eNB 104, a RB 302, and/or a behavior 304) that differs between components associated with the first determined performance and a set of other components associated with the second determined performance, as described above, regarding FIG. 7, for example. In another non-limiting example of device or system 1200 comprising an example CS 102, or portions thereof, device or system 1200 can facilitate sorting the first scheduling priority for the communication device (e.g., one or more user device or equipment, or UE 106, etc.) and sequentially allocating the one or more components of the access system in order, sorting the second scheduling priority for the communication device and sequentially allocating a set of remaining components in reserve order, and so on, as further described herein. Moreover, in further non-limiting implementations of device or system 1200 comprising an example CS 102, or portions thereof, device or system 1200 can facilitate assigning one or more of a RB 302, an eNB 104, or a selected access behavior 304 associated with the communication device.

As further described above regarding FIG. 11, for example, device or system 1200 comprising an example CS 102, or portions thereof, can comprise further components (not shown) (e.g., authentication, authorization and accounting (AAA) servers, e-commerce servers, database servers, application servers, etc.) and/or sub-components in communication with one or more example CS 102, computing systems or devices 1124 associated therewith, computing systems or devices associated with wireless operators, and/or an example UE 106, eNB 104, etc., to accomplish the desired functions, whether complementary, ancillary, or otherwise, without limitation.

As a non-limiting example, in an example implementation, device or system 1200 comprising an example CS 102, or portions thereof, can further comprise a authentication component that can solicit authentication data from UE 106 or other device (e.g., via an operating system, and/or application software, etc.) on behalf of a user, or otherwise, and, upon receiving authentication data so solicited, can be employed, individually and/or in conjunction with information acquired and ascertained as a result of biometric modalities employed (e.g., facial recognition, voice recognition, etc.), verifying received authentication data, and so on. The authentication data can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), encryption key, and so on, for example.

Additionally and/or alternatively, public key infrastructure (PKI) data can also be employed by authentication component. PKI arrangements can provide for trusted third parties to vet, and affirm, entity identity through the use of public keys that typically can be certificates issued by trusted third parties. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

Accordingly, an example authentication component can implement one or more machine-implemented techniques to identify a UE 106 or other device (e.g., via an operating system and/or application software) on behalf of the user, by the user's unique physical and behavioral characteristics and attributes. Biometric modalities that can be employed can comprise, for example, face recognition wherein measurements of key points on an entity's face can provide a unique pattern that can be associated with the entity, iris recognition that measures from the outer edge towards the pupil the patterns associated with the colored part of the eye—the iris—to detect unique features associated with an entity's iris, voice recognition, and/or finger print identification that scans the corrugated ridges of skin that are non-continuous and form a pattern that can provide distinguishing features to identify an entity. Moreover, any of the components described herein (e.g., authentication component, etc.) can be configured to perform the described functionality (e.g., via computer-executable instructions stored in a tangible computer readable medium, and/or executed by a computer, a processor, etc.).

In other non-limiting implementations, device or system 1200 comprising an example CS 102, or portions thereof, can also comprise a cryptographic component that can facilitate encrypting and/or decrypting data and/or information associated with CS 102 to protect such sensitive data and/or information associated with UE 106, such as authentication data, data and/or information employed by one or more eNBs 104, wireless operators, etc. Thus, one or more processors can be associated with a cryptographic component. In accordance with an aspect of the disclosed subject matter, a cryptographic component can provide symmetric cryptographic tools and accelerators (e.g., Twofish, Blowfish, AES, TDES, IDEA, CAST5, RC4, etc.) to facilitate encrypting and/or decrypting data and/or information associated with CS 102.

Thus, an example cryptographic component can facilitate securing data and/or information being written to, stored in, and/or read from a storage component, transmitted to and/or received from a connected network, and/or creating a secure communication channel as part of a secure association of various devices with example implementations of CS 102 comprising non-limiting embodiments of devices or systems 1100, 1200, and so on, or portions thereof, with a UE 106 facilitating various aspects of the disclosed subject matter to ensure that protected data can only be accessed by those entities authorized and/or authenticated to do so. To the same ends, a cryptographic component can also provide asymmetric cryptographic accelerators and tools (e.g., RSA, Digital Signature Standard (DSS), and the like) in addition to accelerators and tools (e.g., Secure Hash Algorithm (SHA) and its variants such as, for example, SHA-0, SHA-1, SHA-224, SHA-256, SHA-384, SHA-512, SHA-3, and so on). As described, any of the components described herein (e.g., cryptographic component, etc.) can be configured to perform the described functionality (e.g., via computer-executable instructions stored in a tangible computer readable medium, and/or executed by a computer, a processor, etc.).

For still other non-limiting implementations, device or system 1200 comprising an example CS 102, or portions thereof, can also comprise a storage component (e.g., which can comprise one or more of a local storage component, a network storage component, a memory, other storage components or subcomponents, etc.) that can facilitate storage and/or retrieval of data and/or information associated with CS 102. Thus, as described above, an example CS 102 comprising device or system 1100, 1200, and so on, or portions thereof, can comprise one or more processors that can be associated with a storage component to facilitate storage of data and/or information, and/or instructions for performing functions associated with and/or incident to the disclosed subject matter as described herein, for example, regarding FIGS. 2-9, etc.

It can be understood that a storage component can comprise one or more computer executable components as described herein, and/or portions thereof, to facilitate any of the functionality described herein and/or ancillary thereto, such as by execution of computer-executable instructions by a computer, a processor, etc. (e.g., one or more processors, etc.). Moreover, any of the components described herein (e.g., a storage component, etc.) can be configured to perform the described functionality (e.g., via computer-executable instructions stored in a tangible computer readable medium, and/or executed by a computer, a processor, etc.).

It should be noted that, as depicted in FIG. 12, devices or systems 1200 are described as monolithic devices or systems. However, it is to be understood that the various components and/or the functionality provided thereby can be incorporated into one or more processors or provided by one or more other connected devices or systems, for example, as described above regarding FIG. 11. Accordingly, it is to be understood that more or less of the described functionality may be implemented, combined, and/or distributed (e.g., among network devices or systems, servers, databases, and the like), according to context, system design considerations, and/or marketing factors. Moreover, any of the components described herein can be configured to perform the described functionality (e.g., via computer-executable instructions stored in a tangible computer readable medium, and/or executed by a computer, a processor, etc.).

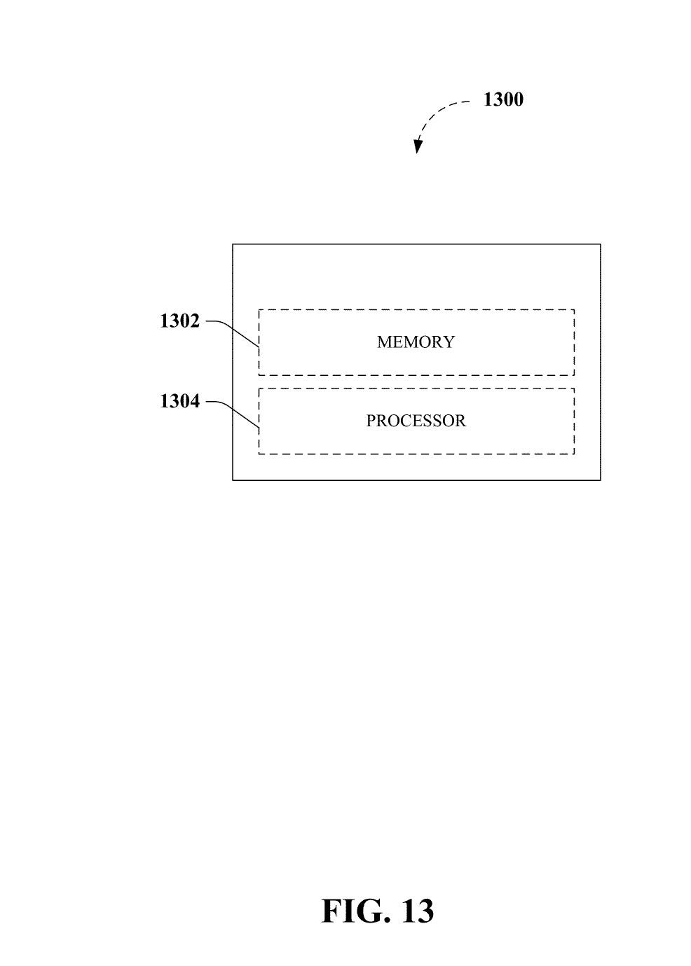

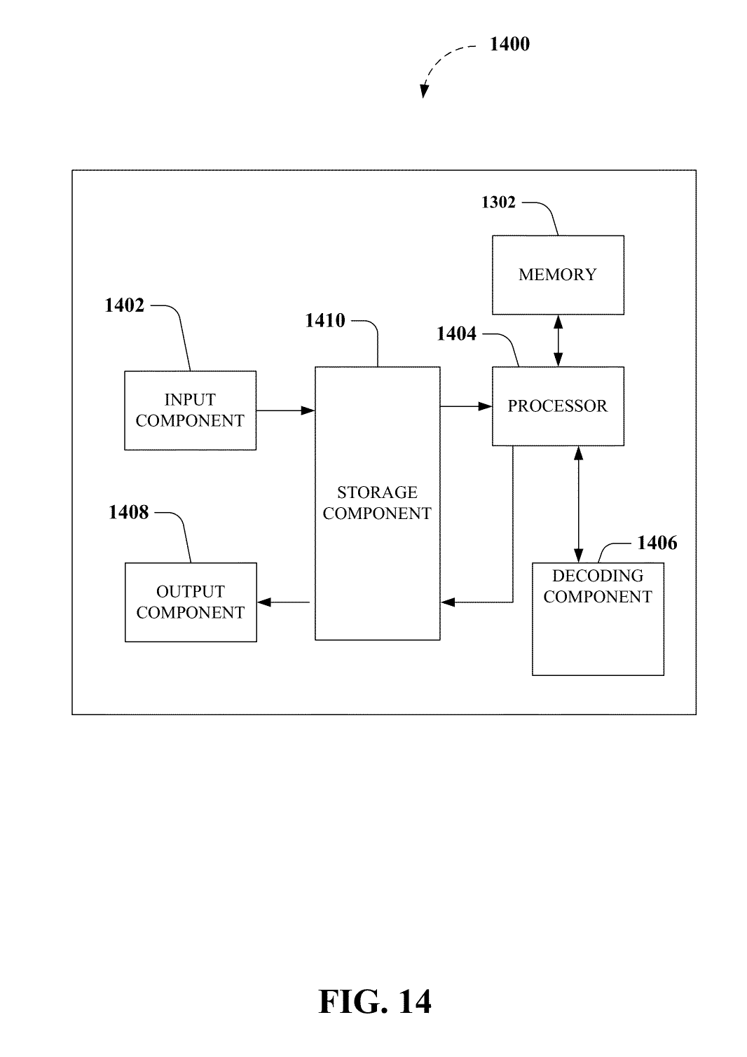

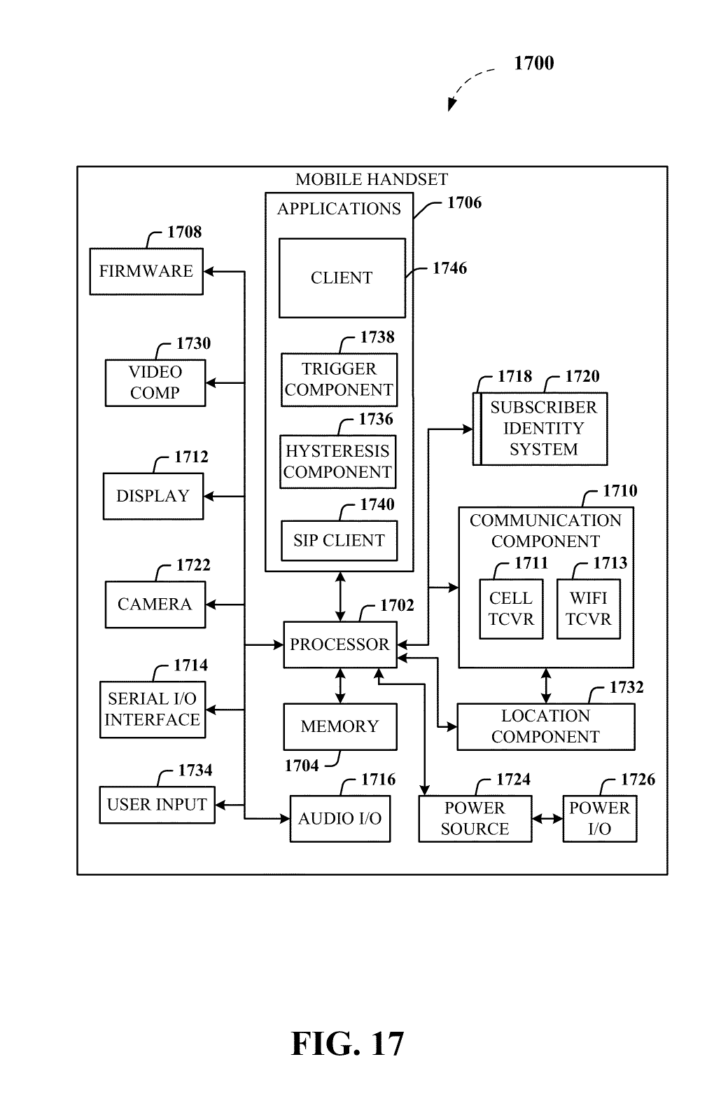

FIG. 13 illustrates an example non-limiting device or system 1300 suitable for performing various aspects of the disclosed subject matter. The device or system 1300 can be a stand-alone device or a portion thereof, a specially programmed computing device or a portion thereof (e.g., a memory retaining instructions for performing the techniques as described herein coupled to a processor), and/or a composite device or system comprising one or more cooperating components distributed among several devices, as further described herein. As an example, example non-limiting device or system 1300 can comprise example devices and/or systems regarding FIGS. 11-12, as described above, or as further described below regarding FIGS. 14 and 17, for example, or portions thereof. For example, FIG. 13 depicts an example device 1300, such as a software-defined radio device (e.g., one or more user device or equipment, or UE 106, etc.).

Accordingly, device or system 1300 can comprise a memory 1302 that retains various instructions with respect to facilitating various operations, for example, such as: transmitting (e.g., via one or more user device or equipment, or UE 106, etc.) information associated with one or more channel conditions (e.g., channel gain, received power, other channel statistics, etc.) between a network node of an access system (e.g., one or more eNBs 104, etc.) and the radio device to a network controller comprising an access allocation system (e.g., an example CS 102, etc.), as described herein, regarding FIGS. 4-7, for example; receiving an access allocation (e.g., SAS 510, etc.) from the network controller, wherein the access allocation (e.g., SAS 510, etc.) can comprise components (e.g., eNB 104, RB 302, and/or behavior 304) of the access system (e.g., one or more eNBs 104, etc.), based on one or more scheduling priorities determined by the access allocation system (e.g., an example CS 102, etc.), based on a performance difference between a first performance associated with the components (e.g., eNB 104, RB 302, and/or behavior 304) and a second performance associated with a set of other components (e.g., eNB 104, RB 302, and/or behavior 304) of the access system (e.g., one or more eNBs 104, etc.) or of one or more other network nodes of the access system (e.g., one or more eNBs 104, etc.); communicating information (e.g., one or more packets or other data or signals representing voice information, textual information, visual information, etc.) to the one or more network nodes of the access system (e.g., one or more eNBs 104, etc.) based on the access allocation (e.g., SAS 510, etc.); encryption; decryption; providing various user or device interfaces; and/or communications routines such as networking, and/or peer-to-peer communications routines, and/or the like.

For instance, device or system 1300 can comprise a memory 1302 that retains instructions for receiving an access allocation including allocation of one or more RBs 302 of one or more eNB devices (e.g., one or more eNBs 104, etc.) based on a first scheduling priority of the one or more scheduling priorities and an allocation of one or more remaining RBs 302 based on a second scheduling priority, wherein the first and second scheduling priorities are based on the performance difference, as further described above regarding FIG. 9, for example.

Additionally, memory 1302 can retain instructions for receiving an access allocation (e.g., SAS 510, etc.) including components (e.g., eNB 104, RB 302, and/or behavior 304) allocated to a cluster and/or group of devices (e.g., one or more user device or equipment, or UE 106, etc.), such as described above regarding FIG. 8, for example, comprising the software-defined radio device (e.g., one or more user device or equipment, or UE 106, etc.) and one or more other communication devices (e.g., one or more user device or equipment, or UE 106, etc.) based on the information associated with the one or more channel conditions (e.g., channel gain, received power, other channel statistics, etc.), a location associated with the software-defined radio device (e.g., one or more user device or equipment, or UE 106, etc.) or the one or more other communication devices (e.g., one or more user device or equipment, or UE 106, etc.), a set of signal strengths from a set of eNB devices (e.g., one or more eNBs 104, etc.) proximate to the software-defined radio device (e.g., one or more user device or equipment, or UE 106, etc.) or the one or more other communication devices (e.g., one or more user device or equipment, or UE 106, etc.), or a number of available RBs 302 for the one or more eNB devices (e.g., one or more eNBs 104, etc.). In still further non-limiting implementations of a device or system 1300, device or system 1300 can comprise a memory 1302 that retains instructions for receiving an access allocation (e.g., SAS 510, etc.) including components (e.g., eNB 104, RB 302, and/or behavior 304) allocated to a cluster of devices (e.g., one or more user device or equipment, or UE 106, etc.), such as described above regarding FIG. 8, for example, comprising the software-defined radio device (e.g., one or more user device or equipment, or UE 106, etc.) and one or more other communication devices (e.g., one or more user device or equipment, or UE 106, etc.) based on the information associated with the one or more channel conditions (e.g., channel gain, received power, other channel statistics, etc.), a location associated with the software-defined radio device (e.g., one or more user device or equipment, or UE 106, etc.) or the one or more other communication devices (e.g., one or more user device or equipment, or UE 106, etc.), signal strength from a set of eNBs 104 proximate to the software-defined radio device (e.g., one or more user device or equipment, or UE 106, etc.) or the one or more other communication devices (e.g., one or more user device or equipment, or UE 106, etc.), or a number of available RBs 302 for the eNB 104.

In addition, in further example implementations, memory 1302 can retain instructions for receiving an access allocation (e.g., SAS 510, etc.) including an access allocation based on the first scheduling priority of the one or more scheduling priorities, where the performance difference is greater than or equal to a first threshold, and based on the second scheduling priority of the one or more scheduling priorities, where a first determined performance associated with the components (e.g., eNB 104, RB 302, and/or behavior 304) is greater than or equal to a second threshold and the performance difference is less than or equal to a third threshold, for example, as described above regarding FIG. 9, etc.

In a further non-limiting example, FIG. 10 describes an example CS 102 and various components and functionality therefor, associated with interactions of one or more UEs 106, one or more eNBs 104, an example CS 102, and others such as wireless operators, etc. Thus, in yet another non-limiting example, memory 1302 can retain instructions with respect to facilitating various operations, as described above regarding FIGS. 5, 9, etc., for example, such as: receiving information associated with one or more channel conditions (e.g., channel gain, received power, other channel statistics, etc.) between a network node of an access system (e.g., one or more eNBs 104, etc.) and a communication device (e.g., one or more user device or equipment, or UE 106, etc.); determining a performance difference between a first determined performance associated with components (e.g., eNB 104, RB 302, and/or behavior 304) of the access system (e.g., one or more eNBs 104, etc.) and a second determined performance associated with a set of other components (e.g., eNB 104, RB 302, and/or behavior 304) of the access system (e.g., one or more eNBs 104, etc.) or the communication device (e.g., one or more user device or equipment, or UE 106, etc.); and/or identifying one or more scheduling priorities based on the information associated with the one or more channel conditions (e.g., channel gain, received power, other channel statistics, etc.) and/or the performance difference.

Additionally, memory 1302 can retain instructions for allocating the components (e.g., eNB 104, RB 302, and/or behavior 304) of the network node access system (e.g., one or more eNBs 104, etc.) to the communication device (e.g., one or more user device or equipment, or UE 106, etc.) based on the one or more scheduling priorities; encryption; decryption; providing various user interfaces; and/or communications routines such as networking, and/or the like. In further non-limiting examples, memory 1302 can retain instructions for determining the performance difference based on one or more of a throughput difference, a capacity difference, or an energy consumption difference associated with one or more of the communication device (e.g., one or more user device or equipment, or UE 106, etc.) or the network node (e.g., one or more eNBs 104, etc.); assigning the performance difference as a first scheduling priority of one or more scheduling priorities, in response to the performance difference being determined to be greater than or equal to a first threshold, for example, as described above regarding FIGS. 5, 9, etc.; assigning the performance difference as a second scheduling priority of one or more scheduling priorities, in response to the first determined performance being determined to be greater than or equal to a second threshold and the performance difference being determined to be less than or equal to a third threshold, as described above regarding FIGS. 5, 9, etc.

In further example implementations, memory 1302 can retain instructions for allocating components (e.g., eNB 104, RB 302, and/or behavior 304) of the access system (e.g., one or more eNBs 104, etc.) to the communication device (e.g., one or more user device or equipment, or UE 106, etc.) and the one or more other communication devices (e.g., one or more user device or equipment, or UE 106, etc.) as a set based on one or more of the one or more scheduling priorities, and wherein the clustering and/or grouping 804 comprises clustering and/or grouping 804 based on one or more of the information associated with the one or more channel conditions (e.g., channel gain, received power, other channel statistics, etc.) between a network node (e.g., one or more eNBs 104, etc.) and communication device (e.g., one or more user device or equipment, or UE 106, etc.), a location associated with the communication device (e.g., one or more user device or equipment, or UE 106, etc.) or the one or more other communication devices (e.g., one or more user device or equipment, or UE 106, etc.), a set of signal strengths from a set of eNB devices (e.g., one or more eNBs 104, etc.) that are proximate to the one or more communication devices or the one or more other communication devices (e.g., one or more user device or equipment, or UE 106, etc.), or a number of available RBs 104 for the one or more eNBs 104; allocating one or more components of the access system (e.g., one or more eNBs 104, etc.) to the communication device (e.g., one or more user device or equipment, or UE 106, etc.) based on the first scheduling priority and allocating one or more remaining components of the access system (e.g., one or more eNBs 104, etc.) based on the second scheduling priority; and/or identifying one or more of the one or more scheduling priorities based on clustering and or grouping 804 one or more communication devices (e.g., one or more user device or equipment, or UE 106, etc.) with one or more other communication devices (e.g., one or more user device or equipment, or UE 106, etc.) regarding the information associated with the one or more channel conditions (e.g., channel gain, received power, other channel statistics, etc.) between a network node (e.g., one or more eNBs 104, etc.) and communication device (e.g., one or more user device or equipment, or UE 106, etc.). In other example implementations, memory 1302 can retain instructions for allocating one or more components (e.g., eNB 104, RB 302, and/or behavior 304) based on the first scheduling priority can including instructions for determining a component (e.g., one of an eNB 104, a RB 302, and/or a behavior 304) that differs between components associated with the first calculated performance and the set of other components associated with the second calculated performance, as described above, regarding FIGS. 7, 9, etc., for example. In still other example implementations, memory 1302 can retain instructions for allocating one or more components of the access system (e.g., one or more eNBs 104, etc.) to the communication device (e.g., one or more user device or equipment, or UE 106, etc.) including instructions for sorting the first scheduling priority for the communication device (e.g., one or more user device or equipment, or UE 106, etc.) and allocating the one or more components of the access system in order, sorting the second scheduling priority for the communication device and allocating a set of remaining components in reserve order, and so on, as further described herein. In addition, memory 1302 can further retain instructions for allocating one or more components of the access system (e.g., one or more eNBs 104, etc.) to the communication device (e.g., one or more user device or equipment, or UE 106, etc.) including instructions for assigning one or more of a RB 302, an eNB 104, or a selected access behavior 304 associated with the communication device.

The above example instructions and other suitable instructions for functionalities as described herein for example, regarding FIGS. 2-12 and 13-14, etc., can be retained within memory 1302, and a processor 1304 can be utilized in connection with executing the instructions.

FIG. 14 illustrates an example non-limiting system or device 1400 suitable for performing various aspects of the disclosed subject matter. As an illustrative example, example non-limiting device or system 1400 can comprise example devices or systems of FIGS. 11-13, as described above, or portions thereof. System or device 1400 can comprise an input component 1402 that can receive data or signals, and performs typical actions thereon (e.g., transmits to storage component 1410) the received data or signal. A storage component 1410 can store the received data or signal, as described above, for example, regarding a storage component, memory 1302, etc., for subsequent processing or can provide it to a decoding component 1406, or a processor (e.g., one or more host processors 1010, 1204, etc.), via a memory (e.g., memory 1302, etc.) over a suitable communications bus or otherwise, or to the output component 1408.

Processor 1404 can be a processor dedicated to analyzing and performing functions on information received by input component 1402 and/or generating information for transmission by an output component 1408. Processor 1404 can be a processor that controls one or more portions of system or device 1400, and/or a processor that analyzes information received by input component 1402, generates information for transmission by output component 1408, and performs various decoding algorithms of decoding component 1406. Decoding component 1406 can comprise various algorithms and routines to facilitate communication according specified network protocols and coding algorithms and/or other functionality as described herein.

While decoding component 1406 is shown external to the processor 1404 and memory 1302, it is to be understood that decoding component 1406 can comprise decoding code, data, and/or instructions stored in storage component 1410, another storage component, memory 1302, etc., and/or subsequently retained in memory 1302 for execution by processor 1404. It can be understood that various routines performed by system or device 1400 can utilize artificial intelligence based methods in connection with performing inference and/or probabilistic determinations and/or statistical-based determinations in connection with various aspects of the disclosed subject matter.

System or device 1400 can additionally comprise a memory (e.g., memory 1302, etc.) that is operatively coupled to processor 1404 and that stores information such as described above, parameters, information, and the like, wherein such information can be employed in connection with implementing various aspects as described herein. Memory 1302 can additionally store received data and/or information (e.g., data and/or information associated with CS 102, one or more eNBs 104, wireless operators, etc.), as well as software routines and/or instructions for functionality as described above in reference to FIGS. 2-13, etc., for example.

As an illustration of a non-limiting implementation of the disclosed subject matter, an example device 1400, such as a software-defined radio device (e.g., one or more user device or equipment, or UE 106, etc.) can be configured or adapted to provide various functionality characterized by a device such as an example UE 106, as described herein, and so on. Referring again to FIG. 14, an example device 1400 can comprise means for transmitting (e.g., via one or more user device or equipment, or UE 106, etc.) information associated with one or more channel conditions (e.g., channel gain, received power, other channel statistics, etc.) between a network node of an access system (e.g., one or more eNBs 104, etc.) and the radio device to a network controller comprising an access allocation system (e.g., an example CS 102, etc.), as described herein, regarding FIGS. 4-7, for example.

In further non-limiting implementations, example device 1400 can also comprise means for receiving an access allocation (e.g., SAS 510, etc.) from the network controller, wherein the access allocation (e.g., SAS 510, etc.) can comprise components (e.g., eNB 104, RB 302, and/or behavior 304) of the access system (e.g., one or more eNBs 104, etc.), based on one or more scheduling priorities determined by the access allocation system (e.g., an example CS 102, etc.), based on a performance difference between a first performance associated with the components (e.g., eNB 104, RB 302, and/or behavior 304) and a second performance associated with a set of other components (e.g., eNB 104, RB 302, and/or behavior 304) of the access system (e.g., one or more eNBs 104, etc.) or of one or more other network nodes of the access system (e.g., one or more eNBs 104, etc.), as further described herein, for example, regarding FIGS. 10,13, etc. For instance, as described herein, example device 1400 can comprise means for receiving an access allocation including allocation of one or more RBs 302 of one or more eNB devices (e.g., one or more eNBs 104, etc.) based on a first scheduling priority of the one or more scheduling priorities and an allocation of one or more remaining RBs 302 based on a second scheduling priority, wherein the first and second scheduling priorities are based on the performance difference, as further described above regarding FIG. 9, for example, etc.

In still further example embodiments, example device 1400 can also comprise means for receiving an access allocation (e.g., SAS 510, etc.) including components (e.g., eNB 104, RB 302, and/or behavior 304) allocated to a cluster of devices (e.g., one or more user device or equipment, or UE 106, etc.), such as described above regarding FIG. 8, for example, comprising the software-defined radio device (e.g., one or more user device or equipment, or UE 106, etc.) and one or more other communication devices (e.g., one or more user device or equipment, or UE 106, etc.) based on one or more of the information associated with the one or more channel conditions (e.g., channel gain, received power, other channel statistics, etc.), a location associated with the software-defined radio device (e.g., one or more user device or equipment, or UE 106, etc.) or the one or more other communication devices (e.g., one or more user device or equipment, or UE 106, etc.), a set of signal strengths from a set of eNB devices (e.g., one or more eNBs 104, etc.) proximate to the software-defined radio device (e.g., one or more user device or equipment, or UE 106, etc.) or the one or more other communication devices (e.g., one or more user device or equipment, or UE 106, etc.), or a number of available RBs 302 for the eNB 104.

In still further non-limiting implementations, example device 1400 can also comprise means for receiving an access allocation (e.g., SAS 510, etc.) including an access allocation based on the first scheduling priority of the one or more scheduling priorities, where the performance difference is greater than or equal to a first threshold, and based on the second scheduling priority of the one or more scheduling priorities, where a first determined performance associated with the components (e.g., eNB 104, RB 302, and/or behavior 304) is greater than or equal to a second threshold and the performance difference is less than or equal to a third threshold, for example, as described above regarding FIG. 9, etc.

In yet other non-limiting implementations, example device 1400 can comprise means for communicating information (e.g., one or more packets or other data or signals representing voice information, textual information, the visual information, etc.) to the one or more network nodes of the access system (e.g., one or more eNBs 104, etc.) based on the access allocation (e.g., SAS 510, etc.); means for encryption; means for decryption; means for providing various user or device interfaces; and/or means for communicating via communications routines such as networking, and/or peer-to-peer communications routines, and/or the like.

Thus, example device 1400 can be configured and/or adapted (e.g., via computer-executable instructions and/or components executed on processor 1404, etc.) to receive (e.g., via input component 1402, etc.), to transmit (e.g., via output component 1408, etc.), to store (e.g., via storage component 1410, etc.), and/or communicate various data and/or information associated with an example CS 102 to facilitate access allocation in HetNets, as further described herein.

It can be appreciated that example device 1400 can be configured and/or adapted in a similar fashion to provide various other functionalities as described herein.

Referring again to FIG. 14, an example system 1400 can comprise means for receiving, by a system comprising a processor (e.g., an example CS 102, etc.), information associated with one or more channel conditions (e.g., channel gain, received power, other channel statistics, etc.) between one or more network nodes (e.g., one or more eNBs 104, etc.) and one or more communication devices (e.g., one or more user device or equipment, or UE 106, etc.), as further described herein, for example, regarding FIGS. 2-9, 12-13, etc. For instance, as described herein, means for receiving can comprise means for receiving information associated with signal strength from a set of eNB devices (e.g., one or more eNBs 104, etc.) that are proximate to the one or more communication devices (e.g., one or more user device or equipment, or UE 106, etc.).

In further non-limiting implementations, example system 1400 can also comprise means for identifying, by the system (e.g., an example CS 102, etc.), one or more scheduling priorities based on the information associated with the one or more channel conditions (e.g., channel gain, received power, other statistics, etc.) between one or more network nodes (e.g., one or more eNBs 104, etc.) and one or more communication devices (e.g., one or more user device or equipment, or UE 106, etc.), as described herein. As a non-limiting example, the means for identifying the one or more scheduling priorities based on the information associated with the one or more channel conditions (e.g., channel gain, received power, other statistics, etc.) between one or more network nodes of an access system (e.g., one or more eNBs 104, etc.) and one or more communication devices (e.g., one or more user device or equipment, or UE 106, etc.) can comprise means for identifying one or more of the scheduling priorities based on grouping and/or clustering 802 the communication device (e.g., one or more user device or equipment, or UE 106, etc.) with one or more other communication devices (e.g., one or more user device or equipment, or UE 106, etc.) regarding the information associated with the one or more channel conditions, as further described herein. In addition, in further example implementations, grouping and/or clustering 802 can also comprise grouping based on one or more of the information associated with the one or more channel conditions, a location associated with the one or more communication devices (e.g., one or more user device or equipment, or UE 106, etc.) or the one or more other communication devices (e.g., one or more user device or equipment, or UE 106, etc.), or a number of available RBs 302 for the one or more eNB devices (e.g., one or more eNBs 104, etc.).

In further non-limiting implementations, example system 1400 can also comprise means for determining, by the system (e.g., an example CS 102, etc.), a performance difference between a first determined performance associated with the components (e.g., eNB 104, RB 302, and/or behavior 304) of the one or more network nodes of an access system (e.g., one or more eNBs 104, etc.) and a second determined performance associated with a set of other components of access system (e.g., one or more eNBs 104, etc.), as further described herein, for example regarding FIGS. 4-7 (e.g., regarding a steep slope region 402, a saturation region 404, DF 506, DoF 508, etc.). Accordingly, in a further non-limiting example, determining a performance difference can comprise determining a performance difference based on one or more of a throughput difference, a capacity difference, or an energy consumption difference associated with one or more of the communication device (e.g., UE 106) or the one or more network nodes (e.g., one or more eNBs 104, etc.).

Moreover, in other non-limiting implementations, example system 1400 can also comprise means for assigning, by the system (e.g., an example CS 102, etc.), the performance difference as a first scheduling priority of the one or more scheduling priorities, in response to the performance difference being determined to be greater than or equal to a first predetermined threshold. For instance, as described above regarding FIG. 5, for example, in a non-limiting implementation employing an example CS 102 as described herein, three predetermined thresholds whose value can be represented by variables, A, B, and C, can be pre-defined. In a non-limiting example, if any slope value is larger than A, then it can be identified as DF 506. In other non-limiting examples, B can be treated as a saturated level or a predetermined level or threshold of performance (e.g., an 80% performance level, etc.), and the performance curve can be inspected after reaching B. In yet other non-limiting examples, if any slope value is smaller than (1−B)/C, then it can be identified as DoF 508.

If CS 102 does not find any DF 506 or DoF 508 following these checks, then both DF 506 and DoF 508 can be assigned with 0, according to further non-limiting aspects. Thus, in non-limiting embodiments employing statistics identification, an example CS 102 can perform one or more threshold determinations as described herein regarding one or more UEs 106 to facilitate determining corresponding DF 506 and DoF 508. Accordingly, in still other non-limiting implementations, example system 1400 can also comprise means for assigning, by the system (e.g., an example CS 102, etc.), the performance difference as a second scheduling priority of the one or more scheduling priorities, in response to the first determined performance being determined to be greater than or equal to a second predetermined threshold and the performance difference being determined to be less than or equal to a third predetermined threshold, as described above, for example, regarding FIG. 9.

In yet other example implementations, example system 1400 can also comprise means for allocating (e.g., sequentially allocating), by the system (e.g., an example CS 102, etc.), components (e.g., eNB 104, RB 302, and/or behavior 304) of the access system (e.g., one or more eNBs 104, etc.) to the communication device (e.g., one or more user device or equipment, or UE 106, etc.) based on the one or more scheduling priorities, as described herein. As a non-limiting example, as described above, it is understood that UEs 106 having different locations can have varying respective channel gains or received power from various eNBs 104 and access behavior 304 can be further decided, accordingly. For instance, as further described herein, regarding FIGS. 3, 7-8, etc., for example, determination of a SAS can further comprise behavior 304 selection and resource block (RB) 302 selection, as further described herein. For instance, it can be understood that a SAS can be constructed by three components (eNB 104, RB 302, and behavior 304). In a non-limiting aspect, access behavior 304 can be function of the number of eNBs 104. As a result, in further non-limiting implementations, SAS 510 allocation can be reduced to a joint selection of eNB 104 and RB 302 (e.g., selection of a horizontal dimension, RB 302 allocation, and a vertical dimension, eNB 104 allocation) as described above regarding FIG. 7, for example.

Accordingly, in still further example implementations, systems 1400 comprising means for sequentially allocating can also comprise means for allocating one or more components (e.g., eNB 104, RB 302, and/or behavior 304) of the access system (e.g., one or more eNBs 104, etc.) to the communication device based on a sorted first scheduling priority (e.g., in order of first scheduling priority, etc.) and allocating at least one remaining component (e.g., eNB 104, RB 302, and/or behavior 304) of the access system to the communication device (e.g., one or more user device or equipment, or UE 106, etc.) based on a reverse-sorted second scheduling priority (e.g., in reverse order of second scheduling priority, etc.). In addition, in yet other example implementations, example system 1400 comprising means for sequentially allocating can also comprise means for allocating at least one resource block (e.g., RB 302) of a eNB device (e.g., eNB 104, etc.) for communication by the communication device (e.g., one or more user device or equipment, or UE 106, etc.) in a selected behavior (e.g., behavior 304). In still other example implementations, systems 1400 comprising means for sequentially allocating can also comprise means for allocating one or more components (e.g., eNB 104, RB 302, and/or behavior 304) based on the first scheduling priority including means for determining a component (e.g., one of an eNB 104, a RB 302, and/or a behavior 304) that differs between components associated with the first calculated performance and the set of other components associated with the second calculated performance, as described above, regarding FIGS. 7, 9, etc., for example. Additionally, in other example implementations, systems 1400 comprising means for sequentially allocating can also comprise means for allocating one or more components of the access system (e.g., one or more eNBs 104, etc.) to the communication device (e.g., one or more user device or equipment, or UE 106, etc.) including means for sorting the first scheduling priority for the communication device (e.g., one or more user device or equipment, or UE 106, etc.) and means for allocating the one or more components of the access system in order, means for sorting the second scheduling priority for the communication device and means for allocating a set of remaining components in reserve order, and so on, as further described herein. In addition, systems 1400 comprising means for sequentially allocating can also comprise means for allocating one or more components of the access system (e.g., one or more eNBs 104, etc.) to the communication device (e.g., one or more user device or equipment, or UE 106, etc.) including means for assigning one or more of a RB 302, an eNB 104, or a selected access behavior 304 associated with the communication device.

Thus, the example system 1400 can be configured and/or adapted (e.g., via computer-executable instructions and/or components executed on one or more processors, processor 1304, processor 1404, etc.) to receive (e.g., via input component 1402, and/or components or portions thereof, etc.), to store (e.g., via storage component 1410, and/or components or portions thereof, etc.), and/or to transmit (e.g., via input component 1402, and/or components or portions thereof, etc.), analyze, schedule, identify, allocate, determine, and/or compute, and so on, information and/or data associated with an example CS 102 that facilitates access allocation in HetNets, as further described herein.

It can be appreciated that example system 1400 can be configured and/or adapted in a similar fashion to provide various other functionalities as described herein.

It will be understood that storage component 1410, or other storage component, memory 1302, and/or any combination thereof as described herein can be either volatile memory or nonvolatile memory, or can comprise both volatile and nonvolatile memory. By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1302 is intended to comprise, without being limited to, these and/or any other suitable types of memory, including processor registers and the like. In addition, by way of illustration and not limitation, storage component 1410 and/or a storage component, can comprise conventional storage media as in known in the art (e.g., hard disk drive, solid state disk (SSD), etc.).

It can be understood that various techniques described herein may be implemented in connection with hardware or software or, where appropriate, with a combination of both. As used herein, the terms “device,” “component,” “system” and the like are likewise intended to refer to a computer-related entity, either hardware, a combination of hardware and software, software, or software in execution. For example, a “device,” “component,” subcomponent, “system” portions thereof, and so on, may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

It can be further understood that while a brief overview of example systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

As can be understood, in example implementations of the disclosed subject matter, various interfaces such as device interfaces, user interfaces such as GUIs, and so on can be provided, for example to facilitate interactions with CS 102 according to various aspects of the disclosed subject matter, among other related functions. In addition, additional embodiments of the disclosed subject matter can provide computer-executable components that can be stored on a tangible computer readable storage medium (e.g., a storage component, storage component 1410, memory 1302, etc.), and that, in response to execution by a computing device (e.g., one or more processors, processor 1304, processor 1404, etc.), can cause the computing device to display information (e.g., on the computing device, on a remote computing device over a network, etc.), for example, such as via a GUI.

For example, FIG. 14 illustrates an example non-limiting block diagram depicting tangible computer readable storage medium, such as storage component 1410 (e.g., a storage component, memory 1302, etc.), that can comprise computer-executable components and that, in response to execution by a computing device (e.g., one or more processors, processor 1304, etc.), can cause the computing device to display information (e.g., on the computing device, on a remote computing device over a network, etc.). In any event, the computer-executable components of the tangible computer readable storage medium can provide a user interface, or other interfaces to facilitate interactions with CS 102, as described herein.

### Example Networked and Distributed Environments

One of ordinary skill in the art can appreciate that the various embodiments of the disclosed subject matter and related systems, devices, and/or methods described herein can be implemented in connection with any computer or other client or server device, which can be deployed as part of a communications system, a computer network, and/or in a distributed computing environment, and can be connected to any kind of data store. In this regard, the various embodiments described herein can be implemented in any computer system or environment having any number of memory or storage units, and any number of applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

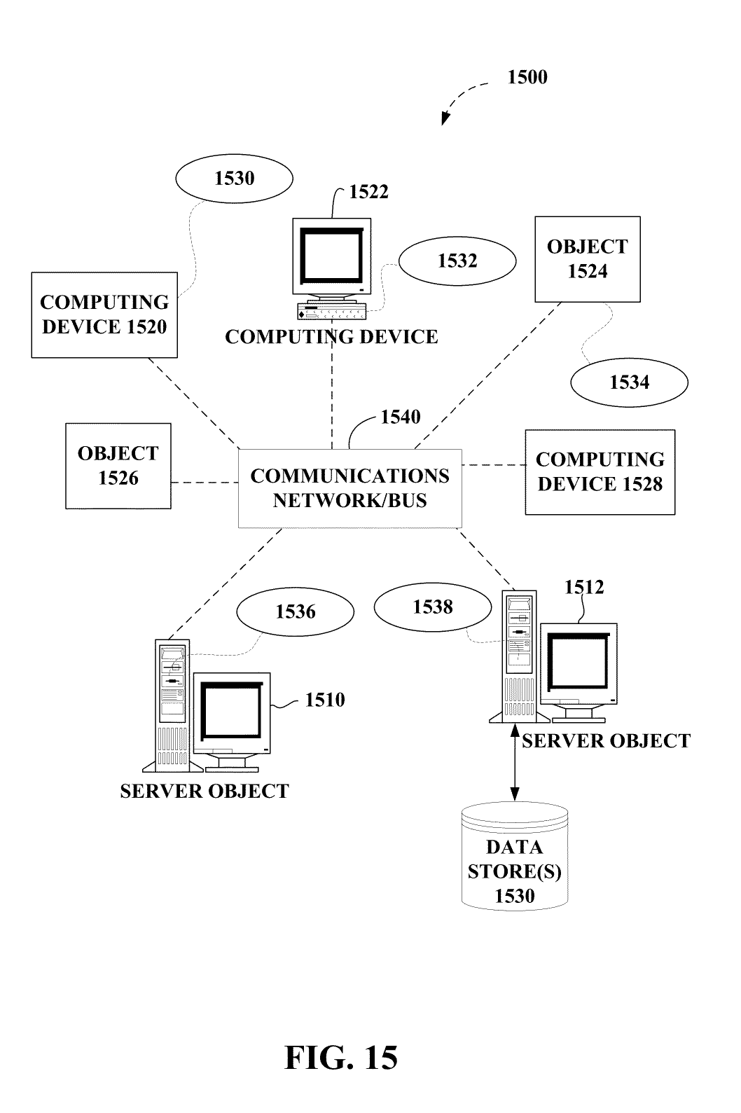

FIG. 15 provides a schematic diagram of an example networked or distributed computing environment. The distributed computing environment comprises computing objects 1510, 1512, etc. and computing objects or devices 1520, 1522, 1524, 1526, 1528, etc., which may include programs, methods, data stores, programmable logic, etc., as represented by applications 1530, 1532, 1534, 1536, 1538. It can be understood that objects 1510, 1512, etc. and computing objects or devices 1520, 1522, 1524, 1526, 1528, etc. may comprise different devices, such as PDAs, audio/video devices, mobile phones, MP3 players, personal computers, laptops, etc.

Each object 1510, 1512, etc. and computing objects or devices 1520, 1522, 1524, 1526, 1528, etc. can communicate with one or more other objects 1510, 1512, etc. and computing objects or devices 1520, 1522, 1524, 1526, 1528, etc. by way of the communications network 1540, either directly or indirectly. Even though illustrated as a single element in FIG. 15, network 1540 may comprise other computing objects and computing devices that provide services to the system of FIG. 15, and/or may represent multiple interconnected networks, which are not shown. Each object 1510, 1512, etc. or 1520, 1522, 1524, 1526, 1528, etc. can also contain an application, such as applications 1530, 1532, 1534, 1536, 1538, that can make use of an API, or other object, software, firmware and/or hardware, suitable for communication with or implementation of disclosed and related systems, devices, methods, and/or functionality provided in accordance with various embodiments of the subject disclosure. Thus, although the physical environment depicted may show the connected devices as computers, such illustration is merely example and the physical environment may alternatively be depicted or described comprising various digital devices, any of which can employ a variety of wired and/or wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many networks are coupled to the Internet, which can provide an infrastructure for widely distributed computing and can encompass many different networks, though any network infrastructure can be used for example communications made incident to employing disclosed and related systems, devices, and/or methods as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 15, as a non-limiting example, computers 1520, 1522, 1524, 1526, 1528, etc. can be thought of as clients and computers 1510, 1512, etc. can be thought of as servers where servers 1510, 1512, etc. provide data services, such as receiving data from client computers 1520, 1522, 1524, 1526, 1528, etc., storing of data, processing of data, transmitting data to client computers 1520, 1522, 1524, 1526, 1528, etc., although any computer can be considered a client, a server, or both, depending on the circumstances. Any of these computing devices may be processing data, forming metadata, synchronizing data or requesting services or tasks that may implicate disclosed and related systems, devices, and/or methods as described herein for one or more embodiments.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to disclosed and related systems, devices, and/or methods can be provided standalone, or distributed across multiple computing devices or objects.

In a network environment in which the communications network/bus 1540 is the Internet, for example, the servers 1510, 1512, etc. can be Web servers with which the clients 1520, 1522, 1524, 1526, 1528, etc. communicate via any of a number of known protocols, such as the hypertext transfer protocol (HTTP). Servers 1510, 1512, etc. may also serve as clients 1520, 1522, 1524, 1526, 1528, etc., as may be characteristic of a distributed computing environment.

### Example Computing Device

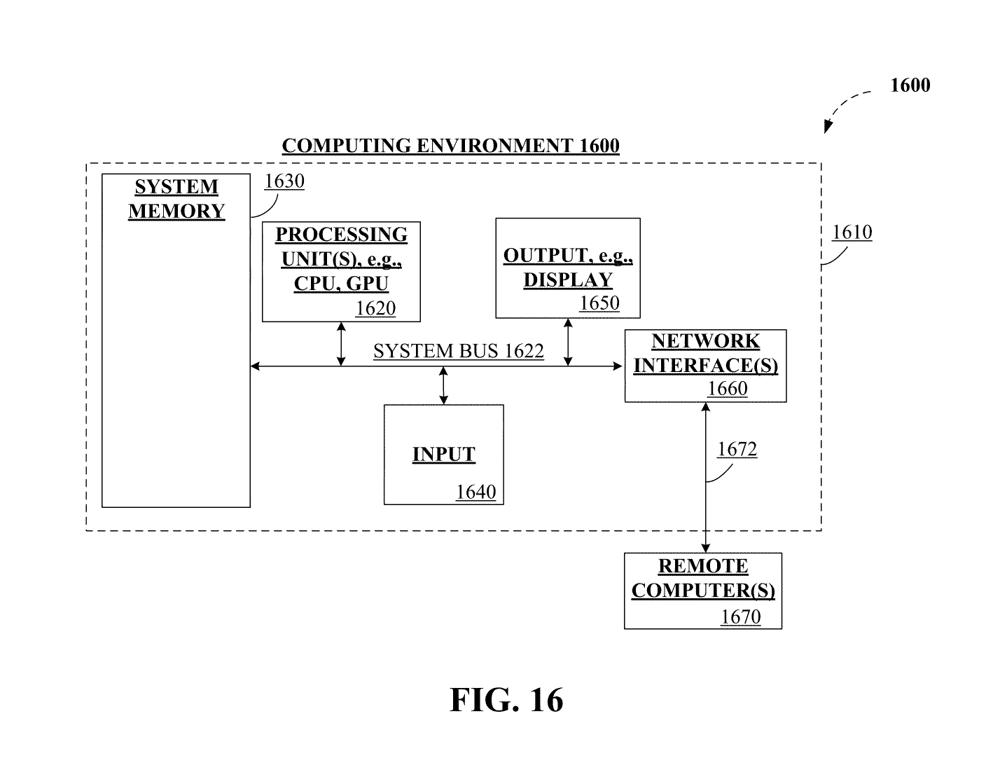

As mentioned, advantageously, the techniques described herein can be applied to devices or systems where it is desirable to employ disclosed and related systems, devices, and/or methods. It should be understood, therefore, that handheld, portable and other computing devices and computing objects of all kinds are contemplated for use in connection with the various disclosed embodiments. Accordingly, the below general purpose remote computer described below in FIG. 16 is but one example of a computing device. Additionally, disclosed and related systems, devices, and/or methods can include one or more aspects of the below general purpose computer, such as display, storage, analysis, control, etc.

Although not required, embodiments can partly be implemented via an operating system, for use by a developer of services for a device or object, and/or included within application software that operates to perform one or more functional aspects of the various embodiments described herein. Software can be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 16 thus illustrates an example of a suitable computing system environment 1600 in which one or aspects of the embodiments described herein can be implemented, although as made clear above, the computing system environment 1600 is only one example of a suitable computing environment and is not intended to suggest any limitation as to scope of use or functionality. Neither should the computing environment 1600 be interpreted as having any dependency or requirement relating to any one or combination of components illustrated in the example operating environment 1600.

With reference to FIG. 16, an example remote device for implementing one or more embodiments includes a general purpose computing device in the form of a computer 1610. Components of computer 1610 can include, but are not limited to, a processing unit 1620, a system memory 1630, and a system bus 1622 that couples various system components including the system memory to the processing unit 1620.

Computer 1610 typically includes a variety of computer readable media and can be any available media that can be accessed by computer 1610. The system memory 1630 can include computer storage media in the form of volatile and/or nonvolatile memory such as read only memory (ROM) and/or random access memory (RAM). By way of example, and not limitation, memory 1630 can also include an operating system, application programs, other program modules, and program data.

A user can enter commands and information into the computer 1610 through input devices 1640. A monitor or other type of display device is also connected to the system bus 1622 via an interface, such as output interface 1650. In addition to a monitor, computers can also include other peripheral output devices such as speakers and a printer, which can be connected through output interface 1650.

The computer 1610 can operate in a networked or distributed environment using logical connections to one or more other remote computers, such as remote computer 1670. The remote computer 1670 can be a personal computer, a server, a router, a network PC, a peer device or other common network node, or any other remote media consumption or transmission device, and can include any or all of the elements described above relative to the computer 1610. The logical connections depicted in FIG. 16 include a network 1672, such local area network (LAN) or a wide area network (WAN), but can also include other networks/buses. Such networking environments are commonplace in homes, offices, enterprise-wide computer networks, intranets and the Internet.

As mentioned above, while example embodiments have been described in connection with various computing devices and network architectures, the underlying concepts can be applied to any network system and any computing device or system in which it is desirable to employ disclosed and related systems, devices, and/or methods.

Also, there are multiple ways to implement the same or similar functionality, e.g., an appropriate API, tool kit, driver code, operating system, control, standalone or downloadable software object, etc. which enables applications and services to use disclosed and related systems, devices, methods, and/or functionality. Thus, embodiments herein are contemplated from the standpoint of an API (or other software object), as well as from a software or hardware object that implements one or more aspects of disclosed and related systems, devices, and/or methods as described herein. Thus, various embodiments described herein can have aspects that are wholly in hardware, partly in hardware and partly in software, as well as in software.

### Example Mobile Device

FIG. 17 depicts a schematic diagram of an example mobile device 1700 (e.g., a mobile handset) that can facilitate various non-limiting aspects of the disclosed subject matter in accordance with the embodiments described herein. Although mobile handset 1700 is illustrated herein, it will be understood that other devices can be a mobile device, as described above regarding FIG. 3, for instance, and that the mobile handset 1700 is merely illustrated to provide context for the embodiments of the subject matter described herein. The following discussion is intended to provide a brief, general description of an example of a suitable environment 1700 in which the various embodiments can be implemented. While the description includes a general context of computer-executable instructions embodied on a tangible computer readable storage medium, those skilled in the art will recognize that the subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer readable media. Computer readable media can comprise any available media that can be accessed by the computer and includes both volatile and non-volatile media, removable and non-removable media. By way of example and not limitation, computer readable media can comprise tangible computer readable storage and/or communication media. Tangible computer readable storage can include volatile and/or non-volatile media, removable and/or non-removable media implemented in any method or technology for storage of information, such as computer readable instructions, data structures, program modules, or other data. Tangible computer readable storage can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media, as contrasted with tangible computer readable storage, typically embodies computer readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable communications media as distinguishable from computer-readable storage media.

The handset 1700 can include a processor 1702 for controlling and processing all onboard operations and functions. A memory 1704 interfaces to the processor 1702 for storage of data and one or more applications 1706 (e.g., communications applications such as browsers, apps, etc.). Other applications can support operation of communications and/or financial communications protocols. The applications 1706 can be stored in the memory 1704 and/or in a firmware 1708, and executed by the processor 1702 from either or both the memory 1704 or/and the firmware 1708. The firmware 1708 can also store startup code for execution in initializing the handset 1700. A communications component 1710 interfaces to the processor 1702 to facilitate wired/wireless communication with external systems, e.g., cellular networks, VoIP networks, and so on. Here, the communications component 1710 can also include a suitable cellular transceiver 1711 (e.g., a GSM transceiver) and/or an unlicensed transceiver 1713 (e.g., Wireless Fidelity (WiFi™), Worldwide Interoperability for Microwave Access (WiMax®)) for corresponding signal communications. The handset 1700 can be a device such as a cellular telephone, a PDA with mobile communications capabilities, and messaging-centric devices. The communications component 1710 also facilitates communications reception from terrestrial radio networks (e.g., broadcast), digital satellite radio networks, and Internet-based radio services networks.

The handset 1700 includes a display 1712 for displaying text, images, video, telephony functions (e.g., a Caller ID function), setup functions, and for user input. For example, the display 1712 can also be referred to as a “screen” that can accommodate the presentation of multimedia content (e.g., music metadata, messages, wallpaper, graphics, etc.). The display 1712 can also display videos and can facilitate the generation, editing and sharing of video quotes. A serial I/O interface 1714 is provided in communication with the processor 1702 to facilitate wired and/or wireless serial communications (e.g., Universal Serial Bus (USB), and/or Institute of Electrical and Electronics Engineers (IEEE) 1794) through a hardwire connection, and other serial input devices (e.g., a keyboard, keypad, and mouse). This supports updating and troubleshooting the handset 1700, for example. Audio capabilities are provided with an audio I/O component 1716, which can include a speaker for the output of audio signals related to, for example, indication that the user pressed the proper key or key combination to initiate the user feedback signal. The audio I/O component 1716 also facilitates the input of audio signals through a microphone to record data and/or telephony voice data, and for inputting voice signals for telephone conversations.

The handset 1700 can include a slot interface 1718 for accommodating a SIC (Subscriber Identity Component) in the form factor of a card Subscriber Identity Module (SIM) or universal SIM 1720, and interfacing the SIM card 1720 with the processor 1702. However, it is to be appreciated that the SIM card 1720 can be manufactured into the handset 1700, and updated by downloading data and software.

The handset 1700 can process Internet Protocol (IP) data traffic through the communication component 1710 to accommodate IP traffic from an IP network such as, for example, the Internet, a corporate intranet, a home network, a person area network, etc., through an ISP or broadband cable provider. Thus, VoIP traffic can be utilized by the handset 1700 and IP-based multimedia content can be received in either an encoded or a decoded format.

A video processing component 1722 (e.g., a camera and/or associated hardware, software, etc.) can be provided for decoding encoded multimedia content. The video processing component 1722 can aid in facilitating the generation and/or sharing of video. The handset 1700 also includes a power source 1724 in the form of batteries and/or an alternating current (AC) power subsystem, which power source 1724 can interface to an external power system or charging equipment (not shown) by a power input/output (I/O) component 1726.

The handset 1700 can also include a video component 1730 for processing video content received and, for recording and transmitting video content. For example, the video component 1730 can facilitate the generation, editing and sharing of video. A location-tracking component 1732 facilitates geographically locating the handset 1700. A user input component 1734 facilitates the user inputting data and/or making selections as previously described. The user input component 1734 can also facilitate selecting perspective recipients for fund transfer, entering amounts requested to be transferred, indicating account restrictions and/or limitations, as well as composing messages and other user input tasks as required by the context. The user input component 1734 can include such conventional input device technologies such as a keypad, keyboard, mouse, stylus pen, and/or touch screen, for example.

Referring again to the applications 1706, a hysteresis component 1736 facilitates the analysis and processing of hysteresis data, which is utilized to determine when to associate with an access point. A software trigger component 1738 can be provided that facilitates triggering of the hysteresis component 1738 when a WiFi™ transceiver 1713 detects the beacon of the access point. A SIP client 1740 enables the handset 1700 to support SIP protocols and register the subscriber with the SIP registrar server. The applications 1706 can also include a communications application or client 1746 that, among other possibilities, can be target for transfer money plugin or user interface component functionality as described above.

The handset 1700, as indicated above related to the communications component 1710, includes an indoor network radio transceiver 1713 (e.g., WiFi™ transceiver). This function supports the indoor radio link, such as IEEE 802.11, for the dual-mode Global System for Mobile Communications (GSM) handset 1700. The handset 1700 can accommodate at least satellite radio services through a handset that can combine wireless voice and digital radio chipsets into a single handheld device.

### Example Communications Networks and Environments

The above-described communication systems using the scheduling techniques, systems, and methods may be applied to any network, however, the following description sets forth some example telephony radio networks and non-limiting operating environments for communications made incident to the communication systems using the scheduling techniques, systems, and methods of the disclosed subject matter. The below-described operating environments should be considered non-exhaustive, however, and thus, the below-described network architecture merely shows one network architecture into which the disclosed subject matter may be incorporated. One can appreciate, however, that the disclosed subject matter may be incorporated into any now existing or future alternative architecture for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the example GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the scheduling techniques, systems, and methods of the disclosed subject matter may be applied independently of the method of data transport, and does not depend on any particular network architecture, or underlying protocols.

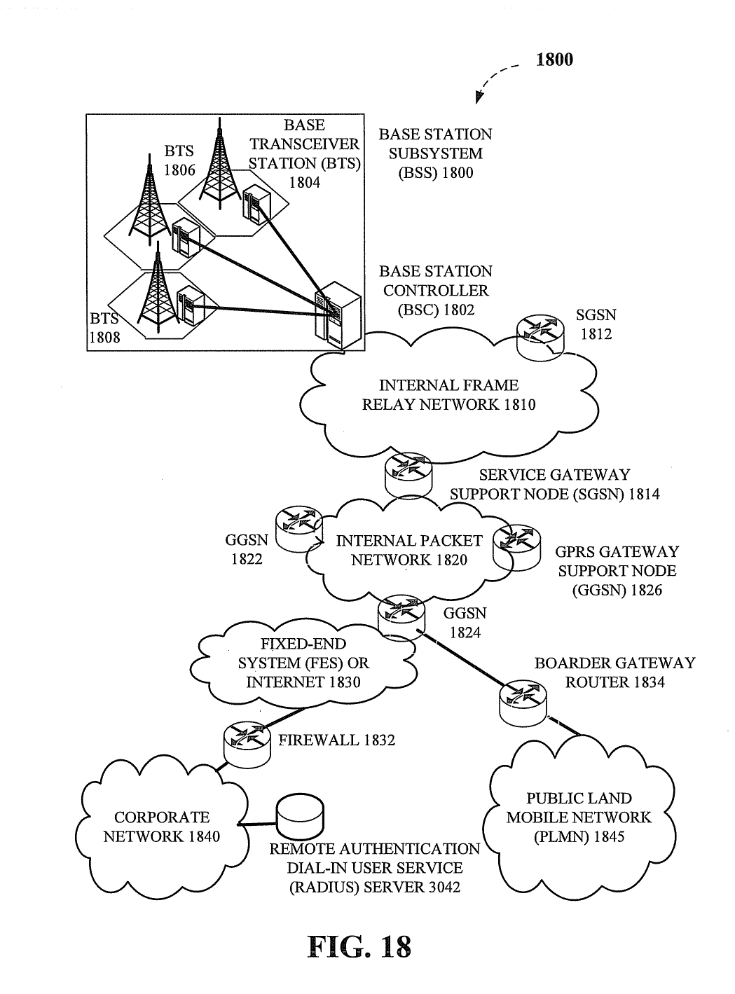

FIG. 18 depicts an overall block diagram of an example packet-based mobile cellular network environment, such as a GPRS network, in which aspects of the disclosed subject matter may be associated or practiced. In such an environment, there are one or more Base Station Subsystems (“BSS”) 1800 (only one is shown), each of which comprises a Base Station Controller (“BSC”) 1802 serving a plurality of Base Transceiver Stations (“BTS”) such as BTSs 1804, 1806, and 1808. BTSs 1804, 1806, 1808, etc. are the access points where users of packet-based mobile devices become connected to the wireless network. In example fashion, the packet traffic originating from user devices is transported over the air interface to a BTS 1808, and from the BTS 1808 to the BSC 1802. Base station subsystems, such as BSS 1800, are a part of internal frame relay network 1810 that may include Service GPRS Support Nodes (“SGSN”) such as SGSN 1812 and 1814. Each SGSN is in turn connected to an internal packet network 1820 through which a SGSN 1812, 1814, etc. can route data packets to and from a plurality of gateway GPRS support nodes (GGSN) 1822, 1824, 1826, etc. As illustrated, SGSN 1814 and GGSNs 1822, 1824, and 1826 are part of internal packet network 1820. Gateway GPRS serving nodes 1822, 1824 and 1826 mainly provide an interface to external Internet Protocol (“IP”) networks such as Public Land Mobile Network (“PLMN”) 1845, corporate intranets 1840, or Fixed-End System (“FES”) or the public Internet 1830. As illustrated, subscriber corporate network 1840 may be connected to GGSN 1824 via firewall 1832; and PLMN 1845 is connected to GGSN 1824 via boarder gateway router 1834. The Remote Authentication Dial-In User Service (“RADIUS”) server 1842 may be used for caller authentication when a user of a mobile cellular device calls corporate network 1840.

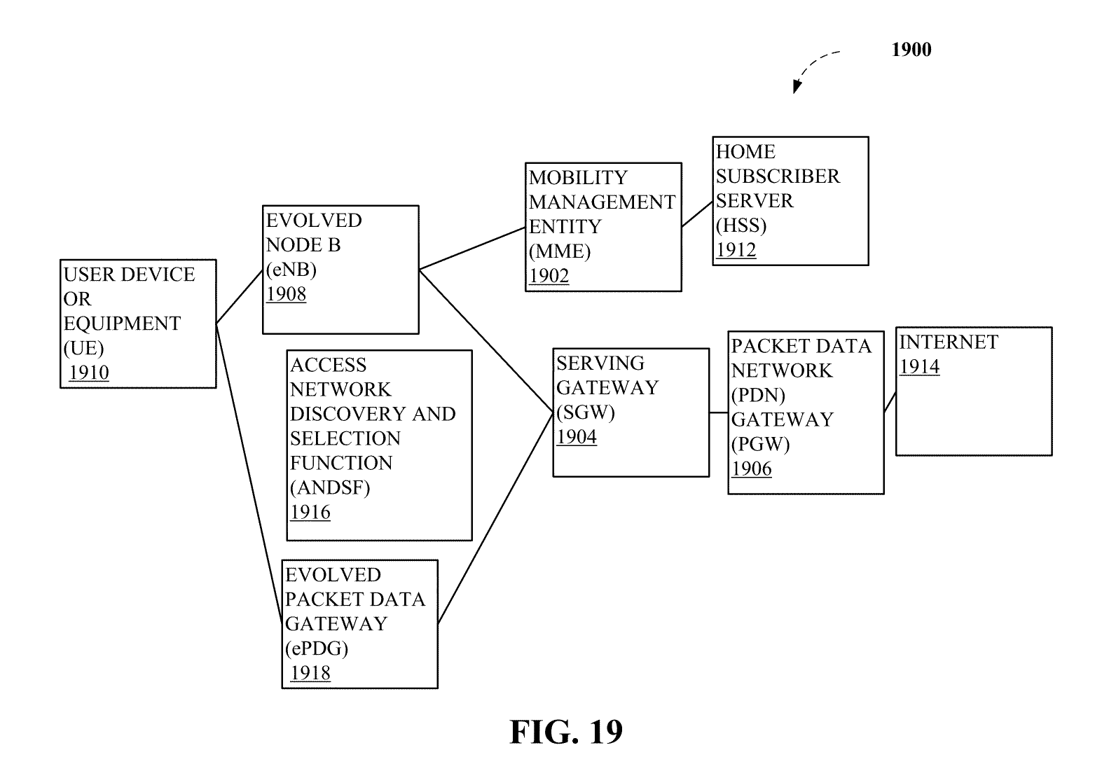

FIG. 19 is a block diagram representing another non-limiting computing system or operating environment in which further aspects of the disclosed subject matter may be implemented. As mentioned, techniques described herein can be applied to devices or systems where it is desirable to employ disclosed and related systems, devices, and/or methods, such as in HetNets as described in LTE-A 3GPP standardization study items. Thus, while various aspects described herein may implicate data, components, and/or functionality as previously described regarding categories of eNBs in HetNets, including the traditional macro eNBs and non-traditional access nodes, it can be appreciated that other aspects can use or implicate other contemporary access nodes including Pico eNBs, or hot-zone cells, Femto eNBs, or Home eNBs, and Remote Radio Head (RRH) and Relay nodes.

As noted, different radio access technologies such as WLAN, WWAN, etc. and different types of access nodes were conventionally operated individually. However, integration of different radio access technologies and different types of eNB is a requirement during 4G evolution that involves employing advanced antenna technologies and network architectures to facilitate utilizing existing networks and/or network entities.

Accordingly, the generalized network architecture described below in FIG. 19 is but one example of an operating environment that can implicate various aspects of the subject disclosure. Additionally, disclosed and related systems, devices, and/or methods can include one or more aspects of the below generalized network architecture, such as display, storage, analysis, control, etc.

FIG. 19, thus, illustrates an example of a suitable operating environment 1900 in which one or aspects of the embodiments described herein can be implemented, although as made clear above, the operating environment 1900 is only one example of a suitable operating environment and is not intended to suggest any limitation as to scope of use or functionality. Neither should the operating environment 1900 be interpreted as having any dependency or requirement relating to any one or combination of components illustrated in the example operating environment 1900.

Thus, operating environment 1900 can comprise components of an IP-based network architecture, such as an Evolved Packet Core (EPC), which can be employed as an advanced network architecture that can facilitate seamless handovers for both voice and data to cell towers with older network technology such as GSM, UMTS and CDMA2000, such as describe above regarding FIG. 18, and can provide support for various cell sizes, from tens of metres radius (femto and picocells), up to 100 kilometers (km) radius macrocells, as mentioned. Accordingly, operating environment 1900 can facilitate employing advanced topology networks to maximum advantage with optimized heterogeneous networks including a mix of macrocells with low power nodes such as picocells, femtocells, and/or new relay nodes.

Operating environment 1900 can comprise a number of components that can implicate various techniques, employ data and/or functionality, and/or transmit and/or receive signals and/or data incident to operation of components as described herein. Thus, in various implementations, operating environment 1900 can comprise an all-IP architecture with separation of control plane and user plane traffic. Thus, operating environment 1900 can comprise one or more components including a Mobility Management Entity (MME) 1902, a Serving Gateway (SGW) 1904, and/or Packet Data Network (PDN) Gateway (PGW) 1906, in addition to one or more eNBs 1908 (e.g., one or more eNBs 104, etc.) that can facilitate packet transmission or reception incident to packet communication with one or more user device or equipment UE 1910 (e.g., UE 106, etc.).

MME 1902 of operating environment 1900 can typically act as a control-node for an LTE access-network. As such, MME 1902 can be responsible for idle mode UE 1910 tracking and/or paging procedures, retransmissions, etc. In addition, MME 1902 can facilitate a bearer activation/deactivation process and choosing SGW 1904 for UE 1910 at an initial attach and at a time of intra-LTE handover involving core network node relocation. In other aspects MME 1902 can facilitate authenticating a user, such as by interacting with a home subscriber server (HSS) 1912. In other aspects, the Non Access Stratum (NAS) signaling, which protocols form the highest stratum of the control plane between UE 1910 and MME 1902, terminates at MME 1902, and can facilitate generation and allocation of temporary identities to UEs 1910. In addition, MME 1902 facilitates ciphering/integrity protection for NAS signaling and can facilitate security key management and interception of signaling by law enforcement. In still further aspects MME 1902 facilitate mobility between LTE and 2G/3G access networks via one or more interfaces with SGSNs (e.g., such as SGSN 1812 and 1814). Any of the aforementioned capabilities and/or aspects of MME 1902 may be employed by, or implicated incident to, various aspects described herein.

SGW 1904 of operating environment 1900 can facilitate routing and/or forwarding user data packets, mobility during handovers between eNBs, and mobility between LTE and other 3GPP technologies via one or more interfaces with 2G/3G systems and PGW 1906. For idle state UEs 1910, SGW 1904 terminates the downlink data path and can facilitate paging when downlink data arrives for a UE 1910. SGW 1904 of operating environment 1900 can also facilitate managing and/or stores UE 1910 contexts (e.g., parameters of an IP bearer service, network internal routing information, etc.). In a law enforcement interception context, SGW 1904 can also facilitate replication of user traffic. Various aforementioned capabilities and/or aspects of SGW 1904 may be employed by, or implicated incident to, various aspects described herein.

PGW 1906 of operating environment 1900 can facilitate connectivity from UE 1910 to external PDNs such as the Internet 1914, for example, by being a point of exit and entry of traffic for a UE 1910. For instance, UE 1910, in various non-limiting aspects, can have simultaneous connectivity with one or more PGWs 1906 for accessing multiple PDNs. Thus, in an aspect, PGW 1906 can facilitate one or more of policy enforcement, packet filtering for users, charging support, lawful interception, and/or packet screening. In another aspect, PGW 1906 can facilitate mobility between 3GPP and non-3GPP technologies (e.g., WiMAX®, 3GPP2 (CDMA 1X and EvDO), etc.). Any of the aforementioned capabilities and/or aspects of PGW 1906 may be employed by, or implicated incident to, various aspects described herein.

Referring again to operating environment 1900 of FIG. 19, a HSS 1912 can comprise a database (e.g., a central database, a distributed database, etc.) that can further comprise user-related and/or subscription-related information. As such HSS 1912 can facilitate mobility management, call and/or session establishment support, user authentication and access authorization, and so on. Accordingly, capabilities and/or aspects of HSS 1912 may be employed by, or implicated incident to, various aspects described herein.

Various implementations of operating environment 1900 can comprise Access Network Discovery and Selection Function (ANDSF) 1916 can facilitate providing information to UE 1910 about connectivity to various networks, according to various aspects of the subject disclosure. For instance, ANDSF 1914 can facilitate providing information to UE 1910 about connectivity to 3GPP access networks and non-3GPP access networks (e.g., WiFi™, etc.). Thus, ANDSF 1916 can facilitate UE 1910 discovery of access networks in the vicinity of UE 1910, providing rules and/or policies to prioritize and manage connections to these networks. As such, various aspects described herein can employ and/or implicate capabilities and/or aspects of ANDSF 1916 and/or related functions.

Further implementations of operating environment 1900 can also comprise Evolved Packet Data Gateway (ePDG) 1918 that can facilitate securing data transmission with UE 1910 connected to components of operating environment 1900 over an untrusted non-3GPP access. For example, in various aspects, for UE 1910 connected to components of operating environment 1900 over an untrusted non-3GPP access, ePDG 1918 can facilitate establishing secure channels (e.g., IPsec tunneling, etc.) with UE 1910. Any of the aforementioned capabilities and/or aspects of ePDG 1918 may be employed by, or implicated incident to, various aspects described herein.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into systems. That is, at least a portion of the devices and/or processes described herein can be integrated into a system via a reasonable amount of experimentation. Those having skill in the art will recognize that a typical system can include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control device (e.g., feedback for sensing position and/or velocity; control devices for moving and/or adjusting parameters). A typical system can be implemented utilizing any suitable commercially available components, such as those typically found in data computing/communication and/or network computing/communication systems.

Various embodiments of the disclosed subject matter sometimes illustrate different components contained within, or connected with, other components. It is to be understood that such depicted architectures are merely example, and that, in fact, many other architectures can be implemented which achieve the same and/or equivalent functionality. In a conceptual sense, any arrangement of components to achieve the same and/or equivalent functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” “operably coupled,” “communicatively connected,” and/or “communicatively coupled,” to each other to achieve the desired functionality, and any two components capable of being so associated can also be viewed as being “operably couplable” or “communicatively couplable” to each other to achieve the desired functionality. Specific examples of operably couplable or communicatively couplable can include, but are not limited to, physically mateable and/or physically interacting components, wirelessly interactable and/or wirelessly interacting components, and/or logically interacting and/or logically interactable components.

With respect to substantially any plural and/or singular terms used herein, those having skill in the art can translate from the plural to the singular and/or from the singular to the plural as can be appropriate to the context and/or application. The various singular/plural permutations may be expressly set forth herein for the sake of clarity, without limitation.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those skilled in the art that, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limit any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those skilled in the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

In addition, the words “example” and “non-limiting” are used herein to mean serving as an example, instance, or illustration. For the avoidance of doubt, the subject matter disclosed herein is not limited by such examples. Moreover, any aspect or design described herein as “an example,” “an illustration,” “example” and/or “non-limiting” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements, as described above.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. In addition, one or more components can reside within a process and/or thread of execution and a component can be localized on one computer and/or distributed between two or more computers.

Systems described herein can be described with respect to interaction between several components. It can be understood that such systems and components can include those components or specified sub-components, some of the specified components or sub-components, or portions thereof, and/or additional components, and various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle component layers, such as a management layer, can be provided to communicatively couple to such sub-components in order to provide integrated functionality, as mentioned. Any components described herein can also interact with one or more other components not specifically described herein but generally known by those of skill in the art.

As mentioned, in view of the example systems described herein, methods that can be implemented in accordance with the described subject matter can be better appreciated with reference to the flowcharts of the various figures and vice versa. While for purposes of simplicity of explanation, the methods can be shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks can be required to implement the methods described hereinafter.

While the disclosed subject matter has been described in connection with the disclosed embodiments and the various figures, it is to be understood that other similar embodiments may be used or modifications and additions may be made to the described embodiments for performing the same function of the disclosed subject matter without deviating therefrom. Still further, multiple processing chips or multiple devices can share the performance of one or more functions described herein, and similarly, storage can be effected across a plurality of devices. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methods, as shown and described herein. In any event, the systems, structures and/or devices, as well as the associated methods described herein have many applications in various aspects of the disclosed subject matter, and so on. Accordingly, the subject disclosure should not be limited to any single embodiment, but rather should be construed in breadth, spirit and scope in accordance with the appended claims.

What is claimed is:

1. A network access allocation method, comprising:
receiving, by a system comprising a processor, information associated with at least one channel condition between at least one network node of an access system and at least one communication device;
identifying, by the system, at least two scheduling priorities based on the information; and
sequentially allocating, by the system, components of the access system to the at least one communication device based on the at least two scheduling priorities.

2. The method of claim 1, wherein the identifying the at least two scheduling priorities comprises determining at least one performance difference between a first determined performance associated with the components and a second determined performance associated with a set of other components of the access system.

3. The method of claim 2, wherein the determining the at least one performance difference comprises determining a performance difference based on at least one of a throughput difference, a capacity difference, or an energy consumption difference associated with at least one of the at least one communication device or the at least one network node.

4. The method of claim 3, further comprising:
assigning, by the system, the at least one performance difference as a first scheduling priority of the at least two scheduling priorities, in response to the performance difference being determined to be greater than or equal to a first predetermined threshold; and
assigning, by the system, the at least one performance difference as a second scheduling priority of the at least two scheduling priorities, in response to the first determined performance being determined to be greater than or equal to a second predetermined threshold and the at least one performance difference being determined to be less than or equal to a third predetermined threshold.

5. The method of claim 4, wherein the sequentially allocating comprises allocating at least one component of the access system to the at least one communication device based on the first scheduling priority and allocating at least one of a set of remaining components of the access system to the at least one communication device based on the second scheduling priority.

6. The method of claim 5, wherein the allocating the at least one component based on the first scheduling priority includes determining that the at least one component differs between the components associated with the first determined performance and the set of other components associated with the second determined performance.

7. The method of claim 5, wherein the allocating the at least one component of the access system to the at least one communication device includes at least one of sorting the first scheduling priority for the at least one communication device and sequentially allocating the at least one component of the access system in order, or sorting the second scheduling priority for the at least one communication device and sequentially allocating the at least one of a set of remaining components in reserve order.

8. The method of claim 1, wherein the sequentially allocating components of the access system includes assigning at least one of a resource block, an evolved nodeB (eNB), or a selected access behavior associated with the at least one communication device.

9. The method of claim 8, wherein the sequentially allocating components of the access system comprises allocating at least one resource block of at least one evolved node B (eNB) device for communication by the at least one communication device in the selected access behavior.

10. The method of claim 8, wherein the receiving information comprises receiving information associated with signal strength from a set of eNB devices that are proximate to the at least one communication device.

11. The method of claim 8, wherein the identifying comprises identifying at least one of the at least two scheduling priorities based on grouping the at least one communication device with at least one other communication device regarding the information associated with the at least one channel condition.

12. The method of claim 11, wherein the sequentially allocating comprises allocating components of the access system to the at least one communication device and the at least one other communication device as a set based on the at least one of the at least two scheduling priorities.

13. The method of claim 11, wherein the grouping comprises grouping based on at least one of the information associated with the at least one channel condition, a location associated with the at least one communication device or the at least one other communication device, or a number of available resource blocks for the at least one eNB device.

14. A tangible computer readable storage medium comprising computer-executable instructions that, in response to execution, cause a computing device comprising a processor to perform operations, comprising:
receiving information associated with a channel condition between a network node in an access system and a communication device;
determining a performance difference between a first determined performance associated with components of the access system and a second determined performance associated with a set of other components of the access system or the communication device;
identifying a plurality of scheduling priorities based on the information and the performance difference; and
allocating the components of the access system to the communication device based on the plurality of scheduling priorities.

15. The tangible computer readable storage medium of claim 14, wherein the determining the performance difference comprises determining the performance difference based on at least one of a throughput difference, a capacity difference, or an energy consumption difference associated with at least one of the communication device or the network node.

16. The tangible computer readable storage medium of claim 14, wherein the operations further comprise:
assigning the performance difference as a first scheduling priority of the plurality of scheduling priorities, in response to the performance difference being determined to be greater than or equal to a first threshold; and
assigning the performance difference as a second scheduling priority of the plurality of scheduling priorities in response to the first determined performance being determined to be greater than or equal to a second threshold and the performance difference being determined to be less than or equal to a third threshold.

17. The tangible computer readable storage medium of claim 16, wherein the allocating comprises allocating at least one component of the access system to the communication device based on the first scheduling priority and allocating at least one remaining component of the access system based on the second scheduling priority.

18. The tangible computer readable storage medium of claim 17, wherein the identifying comprises identifying at least one of the plurality of scheduling priorities based on clustering the communication device with at least one other communication device regarding the information associated with the channel condition.

19. An access allocation system, comprising:
a memory to store computer-executable components; and
a processor communicatively coupled to the memory that facilitates execution of the computer-executable components, the computer-executable components comprising:
an analysis component configured to analyze information associated with at least one channel condition between at least one network node of an access system and a communication device;
a scheduling component configured to identify a plurality of scheduling priorities based on the information; and
an allocation component to sequentially allocate components of the access system to the communication device based on the plurality of scheduling priorities.

20. The access allocation system of claim 19, wherein the scheduling component is further configured to determine a performance difference between a first performance associated with the components and a second performance associated with a set of other components of the access system, wherein the performance difference comprises a difference in performance determined based on at least one of a throughput difference, a capacity difference, or an energy consumption difference associated with at least one of the communication device or the at least one network node.

21. The access allocation system of claim 20, wherein the scheduling component is further configured to assign the performance difference as a first scheduling priority of the plurality of scheduling priorities, in response to the performance difference being determined to be greater than or equal to a first threshold, and assign the performance difference as a second scheduling priority of the plurality of scheduling priorities, in response to a first determined performance associated with the components being determined to be greater than or equal to a second threshold and the performance difference being determined to be less than or equal to a third threshold.

22. The access allocation system of claim 21, wherein the allocation component is further configured to allocate at least one component of the access system to the communication device in order of the first scheduling priority and allocate at least one remaining component of the access system in reverse order of the second scheduling priority.

23. The access allocation system of claim 22, wherein the analysis component is further configured to cluster the communication device with at least one other communication device regarding the information associated with the at least one channel condition based on at least one of the information associated with the at least one channel condition, a location associated with the communication device or the at least one other communication device, a set of signal strengths from a set of evolved node B (eNB) devices proximate to the at least one communication device or the at least one other communication device, or a number of available resource blocks for at least one eNB device, and wherein the allocation component is further configured to allocate components of the access system to the communication device and the at least one other communication device as a cluster based on at least one of the plurality of scheduling priorities.

24. A software-defined radio device, comprising:
means for transmitting information associated with at least one channel condition between at least one network node of an access system and the software-defined radio device to a network controller comprising an access allocation system;
means for receiving an access allocation from the network controller, wherein the access allocation comprises components of the access system based on a plurality of scheduling priorities determined by the access allocation system based on a performance difference between a first performance associated with the components and a second performance associated with a set of other components of the access system; and
means for communicating information to the at least one network node based on the access allocation.

25. The software-defined radio device of claim 24, wherein the access allocation comprises allocation of at least one component of the access system based on a sorted first scheduling priority of the plurality of scheduling priorities and an allocation of at least one remaining component of the access system based on a reverse-sorted second scheduling priority, wherein the first and second scheduling priorities are based on the performance difference.
